(19) United States
(12) Patent Application Publication
(10) Pub. No.: US 2025/0374273 A1
(43) Pub. Date: Dec. 4, 2025

(54) INDICATION METHOD AND DEVICE, AND READABLE STORAGE MEDIUM

(71) Applicant: VIVO MOBILE COMMUNICATION CO., LTD., Dongguan (CN)

(72) Inventors: Chaojun ZENG, Dongguan (CN); Xiaohang CHEN, Dongguan (CN); Xueming PAN, Dongguan (CN)

(73) Assignee: VIVO MOBILE COMMUNICATION CO., LTD., Dongguan (CN)

(21) Appl. No.: 19/303,276

(22) Filed: Aug. 18, 2025

Related U.S. Application Data
(63) Continuation of application No. PCT/CN2024/076507, filed on Feb. 7, 2024.

(30) Foreign Application Priority Data
Feb. 17, 2023 (CN) 202310140536.2

(51) Int. Cl. H04W 72/1268; H04L 5/00; H04L 5/14; H04W 76/20

(52) U.S. Cl. CPC H04W 72/1268; H04L 5/0044; H04L 5/1469; H04W 76/20

(57) ABSTRACT

An indication method and device, and a readable storage medium are provided. The method includes: sending, by a terminal, first indication information to a network-side device during a duration of service data or when a CG resource is present, where the CG resource includes at least one CG PUSCH occasion, the first indication information is used to indicate positions or indexes of used CG PUSCH occasions and positions or indexes of unused CG PUSCH occasions in the CG resource, the first indication information is used to indicate a time period corresponding to used CG PUSCH occasions and a time period corresponding to unused CG PUSCH occasions in the CG resource, or the first indication information is used to indicate used CG PUSCH occasions or unused CG PUSCH occasions in the CG resource in a first time period; and the CG PUSCH occasion is determined to support resource recycling.

### CROSS-REFERENCE TO RELATED APPLICATIONS

This application is a continuation of International Application No. PCT/CN2024/076507, filed Feb. 7, 2024, which claims priority to Chinese Patent Application No. 202310140536.2, filed Feb. 17, 2023. The entire contents of each of the above-referenced applications are expressly incorporated herein by reference.

### TECHNICAL FIELD

This application pertains to the field of communication technologies, and specifically relates to an indication method and device, and a readable storage medium.

### BACKGROUND

When Configured Grant (CG) resources are configured to carry extended reality (extended Reality, XR) service data in uplink, it is currently supported to indicate Unused Configured Grant Physical Uplink Shared Channel occasion (Unused CG PUSCH occasion) based on Uplink Control Information (UCI). However, the specific indication operation and process have not yet been determined.

### SUMMARY

Embodiments of this application provide an indication method and device, and a readable storage medium to address the issue that the specific indication scheme for CG PUSCH occasions has not yet been determined.

According to a first aspect, an indication method is provided, executed by a terminal, where the method includes:
sending, by a terminal, first indication information to a network-side device during a duration of service data or in a case that a CG resource is present; where
the CG resource includes at least one configured grant physical uplink shared channel occasion CG PUSCH occasion, the first indication information is used to indicate positions or indexes of used CG PUSCH occasions and positions or indexes of unused CG PUSCH occasions in the CG resource, or the first indication information is used to indicate a time period corresponding to used CG PUSCH occasions and a time period corresponding to unused CG PUSCH occasions in the CG resource, or the first indication information is used to indicate used CG PUSCH occasions and/or unused CG PUSCH occasions in the CG resource within a first time period; and
the CG PUSCH occasion is determined to support resource recycling.

According to a second aspect, an indication method is provided, executed by a network-side device, where the method includes:
receiving, by a network-side device, first indication information from a terminal during a duration of service data or in a case that a CG resource is present; and
reallocating, by the network-side device, a time-frequency resource corresponding to unused CG PUSCH occasions based on the first indication information; where
the CG resource includes at least one configured grant physical uplink shared channel occasion CG PUSCH occasion, the first indication information is used to indicate positions or indexes of used CG PUSCH occasions and positions or indexes of unused CG PUSCH occasions in the CG resource, or the first indication information is used to indicate a time period corresponding to used CG PUSCH occasions and a time period corresponding to unused CG PUSCH occasions in the CG resource, or the first indication information is used to indicate used CG PUSCH occasions and/or unused CG PUSCH occasions in the CG resource within a first time period; and
the CG PUSCH occasion is determined to support resource recycling.

According to a third aspect, an indication apparatus is provided, where the apparatus is applied to a terminal, and the apparatus includes:
a sending module configured for the terminal to send first indication information to a network-side device during a duration of service data or in a case that a CG resource is present; where
the CG resource includes at least one configured grant physical uplink shared channel occasion CG PUSCH occasion, the first indication information is used to indicate positions or indexes of used CG PUSCH occasions and positions or indexes of unused CG PUSCH occasions in the CG resource, or the first indication information is used to indicate a time period corresponding to used CG PUSCH occasions and a time period corresponding to unused CG PUSCH occasions in the CG resource, or the first indication information is used to indicate used CG PUSCH occasions and/or unused CG PUSCH occasions in the CG resource within a first time period; and
the CG PUSCH occasion is determined to support resource recycling.

According to a fourth aspect, an indication apparatus is provided, where the apparatus is applied to a network-side device and includes:
a receiving module configured for the network-side device to receive first indication information from a terminal during a duration of service data or in a case that a CG resource is present; and
an allocation module configured for the network-side device to reallocate a time-frequency resource corresponding to unused CG PUSCH occasions based on the first indication information; where
the CG resource includes at least one configured grant physical uplink shared channel occasion CG PUSCH occasion, the first indication information is used to indicate positions or indexes of used CG PUSCH occasions and positions or indexes of unused CG PUSCH occasions in the CG resource, or the first indication information is used to indicate a time period corresponding to used CG PUSCH occasions and a time period corresponding to unused CG PUSCH occasions in the CG resource, or the first indication information is used to indicate used CG PUSCH occasions and/or unused CG PUSCH occasions in the CG resource within a first time period; and
the CG PUSCH occasion is determined to support resource recycling.

According to a fifth aspect, a terminal is provided. The terminal includes a processor and a memory. The memory stores a program or instructions executable on the processor. When the program or instructions are executed by the processor, the steps of the method according to the first aspect are implemented.

According to a sixth aspect, a terminal is provided, including a processor and a communication interface, where the communication interface is configured for the terminal to send first indication information to a network-side device during a duration of service data or in a case that a CG resource is present; where
the CG resource includes at least one configured grant physical uplink shared channel occasion CG PUSCH occasion, the first indication information is used to indicate positions or indexes of used CG PUSCH occasions and positions or indexes of unused CG PUSCH occasions in the CG resource, or the first indication information is used to indicate a time period corresponding to used CG PUSCH occasions and a time period corresponding to unused CG PUSCH occasions in the CG resource, or the first indication information is used to indicate used CG PUSCH occasions and/or unused CG PUSCH occasions in the CG resource within a first time period; and
the CG PUSCH occasion is determined to support resource recycling.

According to a seventh aspect, a network-side device is provided. The network-side device includes a processor and a memory. The memory stores a program or an instruction capable of running on the processor. When the program or instruction is executed by the processor, the steps of the method according to the second aspect are implemented.

According to an eighth aspect, a network-side device is provided, including a processor and a communication interface, where the communication interface is configured for the network-side device to receive first indication information from a terminal during a duration of service data or in a case that a CG resource is present; and
reallocating, by the network-side device, a time-frequency resource corresponding to unused CG PUSCH occasions based on the first indication information; where
the CG resource includes at least one configured grant physical uplink shared channel occasion CG PUSCH occasion, the first indication information is used to indicate positions or indexes of used CG PUSCH occasions and positions or indexes of unused CG PUSCH occasions in the CG resource, or the first indication information is used to indicate a time period corresponding to used CG PUSCH occasions and a time period corresponding to unused CG PUSCH occasions in the CG resource, or the first indication information is used to indicate used CG PUSCH occasions and/or unused CG PUSCH occasions in the CG resource within a first time period; and
the CG PUSCH occasion is determined to support resource recycling.

According to a ninth aspect, a readable storage medium is provided, where a program or instructions are stored in the readable storage medium, and when the program or the instructions are executed by a processor, the steps of the method according to the first aspect are implemented, or the steps of the method according to the second aspect are implemented.

According to a tenth aspect, a communication system is provided, and includes a terminal and a network-side device. The terminal may be configured to execute the steps of the method according to the first aspect, and the network-side device may be configured to execute the steps of the method according to the second aspect.

According to an eleventh aspect, a chip is provided. The chip includes a processor and a communication interface, the communication interface is coupled to the processor, and the processor is adapted to run a program or an instruction to implement the method according to the first aspect or the method according to the second aspect.

According to a twelfth aspect, a computer program/program product is provided, where the computer program/program product is stored in a storage medium, and the computer program/program product is executed by at least one processor to implement the method according to the first aspect or the method according to the second aspect.

In the embodiments of this application, during the duration of the service data or in a case that the CG resource is present, the terminal indicates to the network-side device the positions or indexes of the used CG PUSCH occasions and the positions or indexes of the unused CG PUSCH occasions in the CG resource, indicates the time period corresponding to the used CG PUSCH occasions and the time period corresponding to the unused CG PUSCH occasions in the CG resource, or indicates the used CG PUSCH occasions or the unused CG PUSCH occasions in the CG resource within the first time period. This enables the terminal to continuously indicate the usage status of CG PUSCH occasions to the network-side device during the duration of the service data or in a case that the CG resource is present, thereby effectively improving resource utilization efficiency and capacity performance in serving higher-layer service data based on CG resources.

### BRIEF DESCRIPTION OF DRAWINGS

FIG. 1 is a block diagram of a wireless communication system to which the embodiments of this application can be applied;

FIG. 2 is a schematic flowchart of an indication method according to an embodiment of this application;

FIG. 3a is a first schematic diagram of an application scenario according to an embodiment of this application;

FIG. 3b is a second schematic diagram of an application scenario according to an embodiment of this application;

FIG. 3c is a third schematic diagram of an application scenario according to an embodiment of this application;

FIG. 4 is a second schematic flowchart of an indication method according to an embodiment of this application;

FIG. 5 is a first schematic structural diagram of an indication apparatus according to an embodiment of this application;

FIG. 6 is a second schematic structural diagram of an indication apparatus according to an embodiment of this application;

FIG. 7 is a schematic structural diagram of a communications device according to an embodiment of this application;

FIG. 8 is a schematic structural diagram of a terminal according to an embodiment of this application; and

FIG. 9 is a schematic structural diagram of a network-side device according to an embodiment of this application.

### DETAILED DESCRIPTION

The following clearly describes the technical solutions in the embodiments of this application with reference to the accompanying drawings in the embodiments of this application. Apparently, the described embodiments are only some rather than all of the embodiments of this application. All other embodiments obtained by persons of ordinary skill in the art based on the embodiments of this application fall within the protection scope of this application.

The terms “first”, “second”, and the like in this application are used to distinguish between similar objects instead of describing a specific order or sequence. It should be understood that terms used in this way are interchangeable in appropriate circumstances such that the embodiments of this application can be implemented in other orders than the order illustrated or described herein. In addition, objects distinguished by “first” and “second” are generally of a same type, and the quantities of the objects are not limited, for example, there may be one or more first objects. In addition, “and/or” in this application represents at least one of connected objects. For example, “A or B” covers three scenarios: scenario one, including A but not B; scenario two, including B but not A; and scenario three, including both A and B. The character “/” in this specification generally represents an “or” relationship between the associated objects.

The term “indication” in this application can be either a direct indication (or explicit indication) or an indirect indication (or implicit indication). The direct indication can be understood as a sender explicitly informing a receiver of specific information, an operation to be performed, a request result, or the like in a sent indication. The indirect indication can be understood as a receiver determining corresponding information based on an indication sent by a sender, or performing determining based on an indication sent by a sender and determining an operation to be performed or a request result based on the determining result.

It should be noted that technologies described in the embodiments of this application are not limited to a Long Term Evolution (LTE) or LTE-Advanced (LTE-A) system, and may also be applied to other wireless communication systems, for example, Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), or other systems. The terms “system” and “network” in the embodiments of this application are often used interchangeably, and the technology described herein may be used in the above-mentioned systems and radio technologies as well as other systems and radio technologies. In the following descriptions, a new radio (New Radio, NR) system is described for an illustration purpose, and NR terms are used in most of the following descriptions, although these technologies may also be applied to other systems than an NR system application, for example, the 6^{th} Generation (6G) communication system.

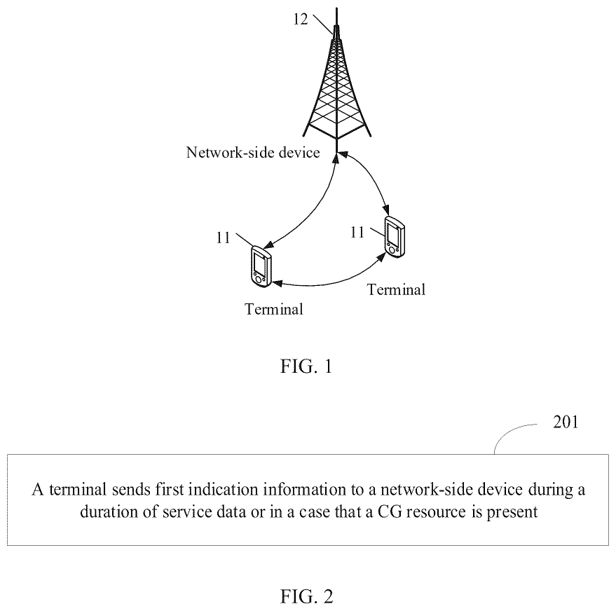

FIG. 1 is a block diagram of a wireless communication system to which the embodiments of this application can be applied. The wireless communications system includes a terminal 11 and a network-side device 12. The terminal 11 can be a mobile phone, tablet personal computer, laptop computer, notebook computer, Personal Digital Assistant (PDA), handheld computer, netbook, Ultra-mobile Personal Computer (UMPC), Mobile Internet Device (MID), Augmented Reality (AR) device, Virtual Reality (VR) device, robot, wearable device, flight vehicle, Vehicle User Equipment (VUE), onboard maritime device, Pedestrian User Equipment (PUE), smart home (wireless communication-enabled home devices such as a refrigerator, television, washing machine, or furniture), game console, Personal Computer (PC), automated teller machine, self-service terminal, or another terminal-side device. The wearable device includes: a smartwatch, a smart band, smart earphones, smart glasses, smart jewelry (such as a smart bracelet, smart bangle, smart ring, smart necklace, smart anklet, or smart foot chain), a smart wristband, smart clothing, and the like. The vehicle user equipment may also be referred to as a vehicle terminal, vehicle controller, vehicle module, vehicle component, vehicle chip, or vehicle unit. It should be noted that the terminal 11 is not limited to a specific type in the embodiments of this application. The network-side device 12 may include an access network device or a core network device. The access network device may also be referred to as a Radio Access Network (RAN) device, a radio access network function, or a radio access network unit. The access network device may include a base station, a Wireless Local Area Network (WLAN) Access Point (AP), a Wireless Fidelity (WiFi) node, or the like. The base station may be referred to as a Node B (NB), an Evolved Node B (eNB), a next generation Node B (gNB), a New Radio Node B (NR Node B), an access point, a relay station (Relay Base Station, RBS), a Serving Base Station (SBS), a Base Transceiver Station (BTS), a radio base station, a radio transceiver, a Basic Service Set (BSS), an Extended Service Set (ESS), a home Node B (HNB), a home evolved Node B, a Transmission Reception Point (TRP), or any other suitable term in the field, as long as the same technical effect is achieved. The base station is not limited to a specific technical term. It should be noted that, in the embodiments of this application, only a base station in an NR system is used as an example for description, and the specific type of the base station is not limited.

To better understand the technical solutions of this application, the following content is introduced first:

### Extended Reality (Extended Reality, XR) Service

Extended reality (extended reality, XR) refers to all real-and-virtual combined environments and human-machine interactions generated by computer technology and wearable devices. It includes representative forms such as Augmented Reality (AR), Mixed Reality (MR), Virtual Reality (VR), and their intersecting fields. The level of the virtual world ranges from partial sensory input to fully immersive virtual reality. A key aspect of XR is the extension of human experience, particularly experience related to the sense of presence (represented by VR) and cognitive acquisition (represented by AR).

For VR services, uplink transmission mainly involves dense small data packets, and these small data packets may carry gesture, control, and other information as input and reference for downlink presentation data. Multimedia data transmission of video, audio, and the like takes the mainstream in downlink, and timely reception and presentation of these multimedia data provides users with an immersive experience. Taking downlink video data as an example, video data can be modeled as video frames based on Frames Per Second (FPS) (frame rate), with a typical FPS value of 60 or 120. These video frames arrive periodically or quasi-periodically based on a period determined by FPS (1/FPS seconds), and the size of the video frames varies dynamically. Each video frame generally requires successful transmission over the air interface within 10 ms, with a transmission success rate requirement of no less than 99% or even 99.9%. Additionally, downlink video data generally requires a quite high data rate, typically reaching tens or even hundreds of Mbps (a typical value is 30/45 Mbps).

For AR services, in addition to the dense small data packets mentioned above, multimedia data such as video, audio, and scene images may also be transmitted in uplink, with service characteristics similar to those in downlink, usually with relatively lower data rates, such as up to tens of Mbps a (typical value is 10/20 Mbps), and the air interface transmission time limit can be relaxed. For example, each video frame generally requires successful transmission within 30 ms. The downlink data transmission characteristics are basically consistent with VR services.

### CG Enhancement for XR Service

To improve the power saving and capacity performance of XR services, various enhancement technologies have been studied and analyzed. To enhance the capacity performance of XR services, numerous enhancement schemes have been intensively discussed and evaluated for configured grant based transmission CG (Configured Grant based transmission), semi-persistent scheduling based transmission SPS (Semi-persistent scheduling based transmission), and dynamic grant based transmission DG (Dynamic Grant based transmission). For CG-related enhancement schemes, the following agreement has been reached:

UE is allowed to dynamically indicate an unused configured grant physical uplink shared channel occasion (Configured Grant Physical Uplink Shared Channel occasion, CG PUSCH) based on UCI (for example, CG-UCI or new UCI).

Based on the characteristics of uplink multimedia data for AR services (video frames arrive periodically or quasi-periodically; and each video frame corresponds to a large and dynamically varying data volume) and transmission requirements (low latency and high reliability), the above agreement can be understood as follows:

To avoid or reduce the latency caused by the Scheduling Request (SR) or Buffer Status Report (BSR) process, a network-side device pre-configures many CG PUSCH occasions to carry uplink multimedia data (mainly video data) for AR services. For example, multiple CG PUSCH occasions are available for each video frame. When data for a video frame arrives, a configured CG PUSCH occasion in close proximity can be directly used to initiate corresponding data transmission, thereby improving latency performance.

In a case that a data volume of a video frame is small, resulting in excessive configured CG PUSCH occasions, the UE can indicate to the network-side device which CG PUSCH occasions are actually unused. This dynamic indication based on Uplink Control Information (UCI) can be understood as a physical (PHY) layer indication of an occupancy status of CG PUSCH occasion for each video frame, so that the network-side device can quickly learn of and determine the actually unused CG PUSCH occasions and use their corresponding time-frequency resources for other purposes (for example, allocating a resource for retransmission for the UE or allocating resources for other UEs), thereby fully utilizing time-frequency resources within a cell and avoiding waste caused by idleness.

In a case that a data volume of a video frame is large, causing a configured CG PUSCH occasion to be insufficient to carry the data volume, the legacy or enhanced BSR process can be used to notify the network-side device to allocate additional DG resources.

The indication method provided by the embodiments of this application is described in detail below through some embodiments and their application scenarios in conjunction with the drawings.

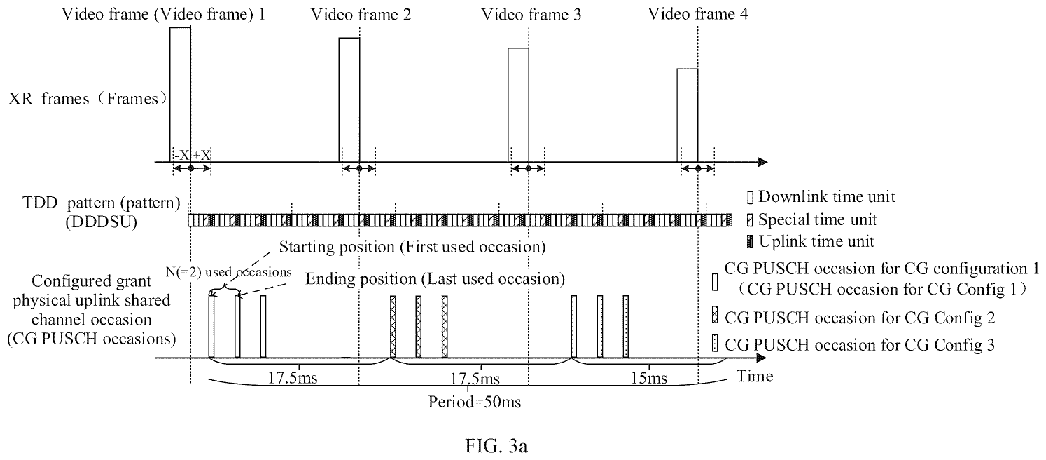

Referring to FIG. 2, an embodiment of this application provides an indication method, the method is executed by a terminal, and the method includes:

Step 201: The terminal sends first indication information to a network-side device during a duration of service data or in a case that a CG resource is present, where the first indication information may also be referred to as resource recycling information, that is, the terminal sending the first indication information to the network side is equivalent to the terminal indicating resource recycling information to the network-side device.

The CG resource includes at least one CG PUSCH occasion, the first indication information is used to indicate positions or indexes of used CG PUSCH occasions and positions or indexes of unused CG PUSCH occasions in the CG resource, or the first indication information is used to indicate a time period corresponding to used CG PUSCH occasions and a time period corresponding to unused CG PUSCH occasions in the CG resource, or the first indication information is used to indicate used CG PUSCH occasions and/or unused CG PUSCH occasions in the CG resource within a first time period.

The CG PUSCH occasion is determined to support resource recycling, and in some embodiments, based on a preset rule (for example, the protocol directly specifies that CG PUSCH occasions used to carry a certain type of service all support resource recycling) or configuration signaling, the CG PUSCH occasion is determined to support resource recycling.

In the embodiments of this application, during the duration of the service data or in a case that the CG resource is present, the terminal indicates to the network-side device the positions or indexes of the used CG PUSCH occasions and the positions or indexes of the unused CG PUSCH occasions in the CG resource, indicates the time period corresponding to the used CG PUSCH occasions and the time period corresponding to the unused CG PUSCH occasions in the CG resource, or indicates the used CG PUSCH occasions or the unused CG PUSCH occasions in the CG resource within the first time period. This enables the terminal to continuously indicate the usage status of CG PUSCH occasions to the network-side device during the duration of the service data or in a case that the CG resource is present, thereby effectively improving resource utilization efficiency and capacity performance in serving higher-layer service data based on CG resources.

It should be noted that the service data mentioned above may refer to service data from a higher layer (for example, an application layer, or an upper layer of an air interface protocol layer of the terminal, or an upper layer of a physical layer of the terminal), such as a video frame of XR service. In the description of the solution in this application, service data or higher-layer service data will be used for description, and the embodiments of this application do not limit the specific category of the service data.

The used CG PUSCH occasion can also be understood as a CG PUSCH occasion that needs to be used, and the unused CG PUSCH occasion can also be understood as a CG PUSCH occasion that does not need to be used. There is no restriction on the temporal sequence between whether the terminal has actually used the CG PUSCH occasion and a time in a case that the terminal sends the indication information to the network-side device. For example, as long as the terminal has determined the CG PUSCH occasion that needs to be used or the CG PUSCH occasion that does not need to be used, it can send the indication information to the network-side device.

In the embodiments of this application, there is no or there is no need to establish a mapping relationship between higher-layer service data (for example, video frames of XR services) and CG PUSCH occasions. During the duration of higher-layer service or during the activation of CG resources, the UE continuously indicates the used/unused state of CG resource to the network-side device. Subsequently, the network-side device can adjust CG resources based on the used CG PUSCH occasions or unused CG PUSCH occasions indicated by the terminal. For example, in a case that a data volume of certain service data is small, resulting in an excess of a configured CG PUSCH occasion, the network-side device can learn and determine actually unused CG PUSCH occasions and use a corresponding time-frequency resource thereof for other purposes (for example, allocating resources for retransmission for this UE or for other UEs), thereby fully utilizing time-frequency resources within a cell and avoiding waste caused by idleness.

In some embodiments, each CG PUSCH occasion carrying higher-layer service data (for example, video frames of XR services) is required to meet a predefined condition.

In an embodiment, the CG PUSCH occasion satisfies at least one of the following:
(1) the CG PUSCH occasion corresponds to a first CG configuration (denoted as CG Config) that is activated and not released.

In some embodiments, the first CG configuration may further satisfy at least one of the following:
(1.1) A serving cell corresponding to the first CG configuration corresponds to a first carrier, where the first carrier is a dedicated carrier for carrying first service data, or the first carrier belongs to a set of dedicated carriers for carrying first service data, the first service data being any service data corresponding to the terminal.
(1.2) The first CG configuration is used to carry only second service data, the second service data being any service data corresponding to the terminal. For example, a configuration index (Config index) corresponding to the CG Config is included in or only included in an allowed configured grant list (allowedCG-List) corresponding to a logical channel corresponding to the higher-layer service data. The allowedCG-List, as an allowed CG configuration list, is used to restrict CG configurations that can carry data corresponding to this logical channel. Only in a case that a Config index corresponding to a CG Config is included in an allowedCG-List configured for a logical channel, a CG PUSCH occasions corresponding to this CG Config can carry data corresponding to this logical channel. The logical channel corresponding to the higher-layer service data may be any logical channel corresponding to higher-layer service data or a logical channel corresponding to the higher-layer service data that meets a predefined requirement. The predefined requirement may be: corresponding to a Quality of Service flow (QOS flow) or Data Radio Bearer (DRB) with a specific attribute (for example, the priority/importance of a carried Protocol Data Unit set (PDU set) is a predefined value or higher than/not lower than a predefined value).
(1.3) The first CG configuration is configured to allow recycling of its corresponding CG PUSCH occasion.

For example, Radio Resource Control (RRC) signaling can be used to explicitly configure whether a CG Config supports resource recycling, and the configuration can be done in any of the following ways:
(1.3.1) directly configuring whether the CG Config supports resource recycling, for example, by introducing a new configuration parameter for each CG Config;
(1.3.2) configuring whether all CG Configs associated with a serving cell/uplink carrier (UL carrier)/Uplink Bandwidth Part (UL BWP) support resource recycling; and
(1.3.3) configuring a CG Config list, whose list items are CG Config or CG Config index, where each CG Config in the list supports resource recycling.

In some embodiments, the CG Config configured to support resource recycling is required to meet other condition items.

In a case that a CG Config is configured to support resource recycling, any of its corresponding CG PUSCH occasions can be recycled as needed, or support resource recycling-related operations. Otherwise, the CG PUSCH occasions corresponding to the CG Config cannot be recycled, and indication information determined by any indication manner described later in the embodiments of this application does not apply to these CG PUSCH occasions.

In a case that the UE carries indication information on the actually occupied/transmitted CG PUSCH occasion, whether a CG PUSCH occasion corresponding to a CG Config configured not to support resource recycling can carry indication information can be handled in any of the following manners:
(a) not carrying indication information, that is, the CG PUSCH occasion carrying no UCI corresponding to the indication information, or does not carry an indication field/bit corresponding to the indication information;
(b) carrying indication information or allowing the carrying of indication information, where if UCI or an indication field/bit (which can be set by the UE to any value or a reserved value) corresponding to the carried indication information is invalid, the network side ignores this indication information; and
(c) carrying indication information or allowing the carrying of indication information, and the function/effect of the carried indication information being the same as that of the indication information carried on the CG PUSCH occasion corresponding to the CG Config configured to support resource recycling.

The specific manner adopted can be specified by the protocol or configured based on higher-layer signaling. For example, RRC signaling is used to configure whether a CG PUSCH occasion corresponding to a CG Config not supporting resource recycling carries indication information or not. In some embodiments, in a case that the CG PUSCH occasion corresponding to the CG Config not supporting resource recycling carries indication information, RRC signaling is used to configure whether the carried indication information takes effect.
(2) The CG PUSCH occasion is a valid CG PUSCH occasion (Valid CG PUSCH occasion).

The valid CG PUSCH occasion can be understood as: symbols occupied by the CG PUSCH occasion are not semi-static downlink symbols (Semi-static DL symbol), or are not indicated as dynamic flexible symbols by Downlink Control Information (DCI) format 2_0, or are not indicated as DL by dynamic scheduling DCI.
(3) A Transport Block (TB) size corresponding to the CG PUSCH occasion is greater than or equal to a preset TB size threshold.
(4) A physical priority (PHY priority) corresponding to the CG PUSCH occasion meets a preset PHY priority value (or the PHY priority configured for the CG Config corresponding to the CG PUSCH occasion meets the preset PHY priority value).

For example, the PHY priority is required to be 1.

That is, each CG PUSCH occasion is required to satisfy at least one of the predefined conditions corresponding to (1) to (4) above.

The sending of the first indication information in step 201 involves the ordering of CG PUSCH occasions (determining the sequence) or the determination of indices.

In an embodiment, the method further includes:
in a scenario where Carrier Aggregation (CA) is not supported, or in a case of determining the ordering or indices of multiple CG PUSCH occasions (in the embodiments of this application, multiple refers to at least two) within only a single serving cell, determining, by the terminal, the ordering or indices of the multiple CG PUSCH occasions based on at least one of the following:
(1) starting times or ending times of the CG PUSCH occasions;
(2) a configuration index of the CG configuration corresponding to the CG PUSCH occasion; or
(3) the TB size, the number of frequency-domain Physical Resource Block (PRB), or the number of time-domain symbols corresponding to the CG PUSCH occasion.

For scenarios where CA is not considered or not supported, in some embodiments, the UE does not expect the CG PUSCH occasion corresponding to the higher-layer service data to correspond to more than one serving cell (that is, located on more than one serving cell), or the UE considers only a CG PUSCH occasion corresponding to a single serving cell (for example, a serving cell with the smallest index).

In an embodiment, the method further includes:
in a scenario where carrier aggregation CA is supported, or in a case that determining the ordering or indices of multiple CG PUSCH occasions across serving cells, determining, by the terminal, the ordering or indices of the multiple CG PUSCH occasions based on at least one of the following:
(1) starting times or ending times of the CG PUSCH occasions;
(2) an index of a serving cell where the CG PUSCH occasion is located or corresponds to;
(3) a configuration index of the CG configuration corresponding to the CG PUSCH occasion; or
(4) the TB size, the number of PRBs, or the number of time-domain symbols corresponding to the CG PUSCH occasion.

For example, in a scenario where CA is supported, a traversal mechanism similar to the Downlink assignment index (DAI) numbering mechanism can be adopted. The following examples can be distinguished, and corresponding operations can be performed:

Example 1: For two CG PUSCH occasions with different starting/ending times, the CG PUSCH occasion with an earlier starting/ending time is traversed first (or assigned with a smaller index).

Example 2: For two CG PUSCH occasions with the same starting/ending time, in a case that their corresponding serving cell indices are different, the CG PUSCH occasion corresponding to the serving cell with a smaller index is traversed first (or assigned with a smaller index).

Example 3: In a case that two CG PUSCH occasions have the same starting/ending time and correspond to the same serving cell index, there is (at least time-domain) overlapping of the CG PUSCH occasions. In this case, their corresponding CG Configs' Config indices should be different (assuming that CG PUSCH occasions corresponding to the same CG Config have no overlapping in the time domain), and the CG PUSCH occasion corresponding to the CG Config with a smaller Config index is traversed first (or assigned with a smaller index).

In some embodiments, for Example 3, the traversal order can also be determined based on the TB size/frequency-domain PRB number/number of time-domain symbols corresponding to the CG PUSCH occasion. For example, assuming that priority is given to occupy a CG PUSCH occasion with a larger TB size, in a case that TB sizes corresponding to two CG PUSCH occasions are different, the CG PUSCH occasion with the larger TB size is traversed first (or assigned with a smaller index).

It can be understood that, for the scenario where CA is not supported or supported, the CG PUSCH occasion here is required to meet the predefined condition that the foregoing CG PUSCH occasion needs to satisfy.

The embodiments of this application provide several specific methods for indicating to the network-side device the used CG PUSCH occasions or unused CG PUSCH occasions in the CG resource corresponding to the service data, where the indication from the UE to the network-side device is carried by UCI, which may be CG-UCI or UCI processed similarly to CG-UCI (in which case UCI is carried on CG PUSCH), or newly introduced UCI (in which case UCI may be carried on PUCCH or PUSCH). The embodiments of this application do not specifically limit this.

In an embodiment, the sending, by a terminal, first indication information to a network-side device includes: sending, by the terminal, to the network-side device first information corresponding to the used CG PUSCH occasions and second information corresponding to the unused CG PUSCH occasions.

Indication manner 1: Assuming that when the UE needs to use the CG resource, it always occupies consecutive CG PUSCH occasion(s) in terms of position (index), the UE indicates both information corresponding to used CG PUSCH occasion(s) and information corresponding to unused CG PUSCH occasion(s).

Indication manner 1-1: in an embodiment, the first information includes at least one of the following:
(1) a starting position or starting index of the used CG PUSCH occasions,
(2) an ending position or ending index of the used CG PUSCH occasions, or
(3) the number of the used CG PUSCH occasions, for example, the number of consecutive used CG PUSCH occasions; and
the second information includes at least one of the following:
(1) a starting position or starting index of the unused CG PUSCH occasions,
(2) an ending position or ending index of the unused CG PUSCH occasions, or
(3) the number of the unused CG PUSCH occasions, for example, the number of consecutive unused CG PUSCH occasions.

It can be understood that in indicating the position or index of a CG PUSCH occasion, at least one of the following may be indicated to identify this CG PUSCH occasion:
(1) a starting/ending time of the CG PUSCH occasion, where the time may be indicated in terms of system time-domain unit (radio frame, slot, symbol, or the like) or absolute time unit (ms or the like);
(2) an index of a serving cell where the CG PUSCH occasion is located/corresponds to;
(3) a Config index of the CG Config corresponding to the CG PUSCH occasion;
(4) an index of a CG PUSCH occasion among CG PUSCH occasion(s) since the configuration/reconfiguration or the most recent activation of the corresponding CG Config (indexing may start from 0 or 1); or
(5) index of a CG PUSCH occasion among all CG PUSCH occasion(s) configured for the UE/this higher-layer service since the start/restart of the higher-layer service (indexing may start from 0 or 1).

In an embodiment, the first information is used to indicate any one of the following:
(1) N used CG PUSCH occasions starting from the 1st used CG PUSCH occasion (that is, starting position), where N is a positive integer, or
(2) all used CG PUSCH occasions from the 1st used CG PUSCH occasion (that is, starting position) to the last used CG PUSCH occasion (that is, ending position); and
the second information is used to indicate any one of the following:
(1) starting from the 1st unused CG PUSCH occasion, none of CG PUSCH occasions before a first CG PUSCH occasion is required to use,
(2) from the 1st unused CG PUSCH occasion to a second CG PUSCH occasion, none of CG PUSCH occasions covered or involved is required to use, or
(3) none of M CG PUSCH occasions starting from the 1st unused CG PUSCH occasion is required to use, where M is a positive integer, where
the 1st used CG PUSCH occasion (that is, first used CG PUSCH occasion) is any one of the following:
(1) the 1st CG PUSCH occasion carrying the service data, where the service data can be understood as the most recent to-be-transmitted uplink service data item received from a service source by the terminal before it sends the first information, such as the most recent video frame; or
(2) the 1st CG PUSCH occasion carrying UCI corresponding to the first indication information.

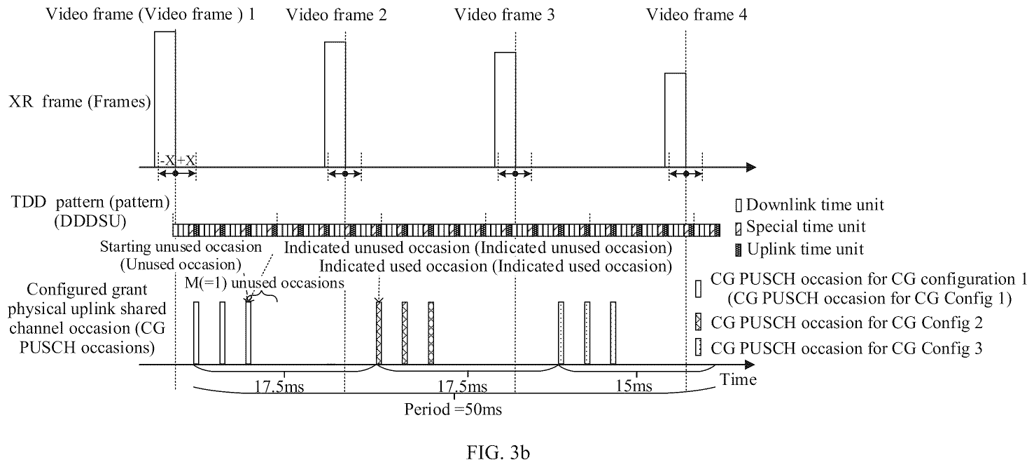

In some embodiments, referring to the application scenario shown in FIG. 3a, the video frame corresponds to 60 FPS, and the serving cell adopts a conventional DDDSU (D represents a downlink time unit, S represents a special time unit, and U represents an uplink time unit, arranged in the order of three downlink time units, one special time unit, and one uplink time unit) as the Time-division Duplex (TDD) pattern. To ensure that the configured CG PUSCH occasions are actually available, in a case of determining the CG configuration parameters (that is, the configuration parameters corresponding to the CG Config), it can be ensured that each CG PUSCH occasion corresponds to the uplink time unit in the TDD pattern. In addition, in a case that multiple CG PUSCH occasions can be configured within a single period of a single CG Config, considering that the video frame corresponds to a non-integer periodicity, which does not closely match the period values that can be configured for the CG Config, suitable CG resource can be configured for the video frame by configuring multiple CG Configs. In FIG. 3a, three CG Configs are configured, each CG Config has a period of 50 ms, and reasonable offset configurations ensure that the CG PUSCH occasion(s) configured within a single period of each CG Config align as closely as possible with the expected arrival time of the corresponding video frame. In FIG. 3a, each CG Config configures three CG PUSCH occasions within a single period, and CG PUSCH occasions corresponding to different CG Configs are distinguished by different fill patterns. It should be noted that FIG. 3a illustrates only a scenario where an occasion set includes three CG PUSCH occasions. This application does not specifically limit the number of CG PUSCH occasions included in an occasion set, nor does it limit whether the CG PUSCH occasions included in each occasion set correspond to the same or different CG Configs.

The UE indicates N used CG PUSCH occasion(s) starting from the first used CG PUSCH occasion (that is, starting position), or all used CG PUSCH occasion(s) from the first used CG PUSCH occasion (that is, starting position) to the last used CG PUSCH occasion (that is, ending position).

For the first used CG PUSCH occasion, it can be any one of the following:
(1) the 1st CG PUSCH occasion carrying the current higher-layer service data for the UE.

The determination of the first used CG PUSCH occasion can be done in any of the following ways:
(a) Determined through blind detection by the network-side device

The higher-layer service data being video frames of XR services is used as an example, and each video frame arrives at the UE's UL buffer periodically (in a case that there is no jitter or quasi-periodically (in a case that there is jitter), and the FPS corresponding to the period can be known in advance by both sides. In a case that jitter is not considered, the offset of each video frame relative to each period can also be basically understood consistently by both sides through implementation or reporting via BSR/UAI, so it can be considered that the expected arrival time of each video frame is understood consistently by both sides in a case that jitter is not considered. The expected arrival time of each video frame can be understood as the expected latest time in a case that the PDU (or Internet Protocol (IP) packet) corresponding to this video frame arrives at the air interface UL buffer, which can be determined or approximately determined based on the period and offset.

In a case that there is no jitter in the arrival of video frames, the network-side device can start detecting from the 1st CG PUSCH occasion after the expected arrival time of a video frame to determine whether it is actually occupied by the UE or carries data corresponding to the video frame, thereby determining the 1st CG PUSCH occasion carrying the higher-layer service data for the UE.

In a case that there is jitter in the arrival of video frames, assuming that the uplink jitter range can be basically understood consistently by both sides through implementation or reporting via UAI, and the jitter range is [−X, +X] (measured in absolute time such as ms, or time-domain unit such as slot or symbol), the network-side device can start detecting from the 1st CG PUSCH occasion after (the expected arrival time of a video frame −X) to determine whether it is actually occupied by the UE or carries data corresponding to the video frame, thereby determining the 1st CG PUSCH occasion carrying the higher-layer service data for the UE.

It should be noted that whether a CG PUSCH occasion is actually used by the UE can be detected based on the Demodulation Reference Signal (DM-RS) (for example, using energy detection or sequence detection). In addition, whether a CG PUSCH occasion actually used by the UE carries higher-layer service data can be identified through an LCID in a carried TB, for example, a logical channel identifier (LCID) of a MAC Sublayer Protocol Data Unit (MAC Sub-PDU) in the TB corresponds to at least one logical channel corresponding to the higher-layer service data.
(b) Explicitly indicated by the UE.

In this case, the first used CG PUSCH occasion can be indicated in the same UCI as the value N or the last used CG PUSCH occasion (in which case, the network-side device may still need to perform blind detection on the used CG PUSCH occasion, for example, blindly detecting a used CG PUSCH occasion, and determining this used CG PUSCH occasion (the blind-detected used CG PUSCH occasion carrying the current higher-layer service data) or a subsequent used CG PUSCH occasion (the blind-detected used CG PUSCH occasion not carrying the current higher-layer service data) as the first used CG PUSCH occasion based on UCI carried in this used CG PUSCH occasion), or can be indicated in independent UCI, in which case this independent UCI can be carried by PUCCH or other PUSCH.
(2) The 1st CG PUSCH occasion carrying UCI corresponding to resource recycling information.

Here, it is assumed that only in a case that the UE needs to use UCI to indicate resource recycling information to the network-side device does the UE carry UCI in the CG PUSCH occasion (that is, UCI is carried on CG PUSCH) and use this UCI to carry resource recycling information. For example, only for CG PUSCH occasions corresponding to a CG Config configured to support resource recycling does the UE carry UCI in any actually occupied CG PUSCH occasion, or the UE carries UCI in one or some of the actually occupied CG PUSCH occasions. For the latter, it is assumed that the network side determines whether a (actually used by the UE) CG PUSCH occasion carries UCI corresponding to resource recycling information through blind detection.
(3) The 1st CG PUSCH occasion actually occupied or transmitted by the terminal.

As compared with the previous two items, this relaxes the requirements, that is, it is not required to determine whether the PUSCH transmission corresponding to the CG PUSCH occasion carries the current higher-layer service data or UCI corresponding to resource recycling information. In this case, whether a CG PUSCH occasion is actually occupied/transmitted by the UE can be detected based on DM-RS (for example, using energy detection or sequence detection).
(4) A CG PUSCH occasion following the last CG PUSCH occasion indicated by a previous window, where the window is a window corresponding toof the first indication information in time domain, and the window includes at least one used CG PUSCH occasion, or the window includes at least one used CG PUSCH occasion and at least one unused CG PUSCH occasion.

The last unused CG PUSCH occasion indicated by the previous window refers to the unused CG PUSCH occasion with the latest position or the largest index among the unused CG PUSCH occasion(s) involved in the information corresponding to the unused CG PUSCH occasion(s) indicated by the previous window.

For the window mentioned above, generally, it is assumed that used CG PUSCH occasion(s) and unused CG PUSCH occasion(s) appear alternately, that is, at least one used CG PUSCH occasion is followed by zero/one/multiple unused CG PUSCH occasions (there may be a gap between any two adjacent CG PUSCH occasions, determined based on the TDD pattern). The at least one used CG PUSCH occasion and the subsequent zero/one/multiple unused CG PUSCH occasions can constitute a window (that is, the time-domain window corresponding to the indication information, involving one or more CG PUSCH occasions within the window). The indices of CG PUSCH occasions corresponding to adjacent windows may be continuous or discontinuous (In a case that the information corresponding to indicated unused CG PUSCH occasion(s) does not cover all unused CG PUSCH occasion(s). For example, the last unused CG PUSCH occasion indicated by the previous window is not the CG PUSCH occasion immediately before the 1st used CG PUSCH occasion indicated by the next window, depending on the indication of the information corresponding to the unused CG PUSCH occasion(s), the determination of the first used CG PUSCH occasion, and the like).

For N used CG PUSCH occasion(s) starting from the first used CG PUSCH occasion (that is, starting position), the UE can indicate the value N in the UCI.

In a case that the UE indicates the last used CG PUSCH occasion, any of the following ways can be used:
(1) the UE explicitly indicates the position or index of the last used CG PUSCH occasion; and
(2) for an actually used CG PUSCH occasion, the UE (by using 1 bit) indicates whether it is the last used CG PUSCH occasion.

In a case that the UE indicates that it is the last used CG PUSCH occasion (for example, when the UE has completed the transmission of the current higher-layer service data using the used CG PUSCH occasion(s), indicating that the last CG PUSCH occasion among these used CG PUSCH occasion(s) is the last used CG PUSCH occasion), the UE and the network-side device can consider that the CG PUSCH occasion(s) starting from the next CG PUSCH occasion may be unused CG PUSCH occasion(s) (both sides can further determine the actual number of the unused CG PUSCH occasion(s) based on the information corresponding to the unused CG PUSCH occasion(s) indicated by the UE).

Here, it is assumed that the UE carries UCI in each actually occupied CG PUSCH occasion (that is, UCI is carried on CG PUSCH) and indicates whether this CG PUSCH occasion is the last used CG PUSCH occasion (for example, using 1 bit for indication, where the value of 1 indicates the last used CG PUSCH occasion).

The 1st unused CG PUSCH occasion is explicitly indicated by the terminal in the uplink control information UCI, or the 1st unused CG PUSCH occasion is implicitly determined based on the last used CG PUSCH occasion.

Accordingly, in a case that the UE indicates information corresponding to unused CG PUSCH occasion(s), it indicates that from the starting unused CG PUSCH occasion to a certain CG PUSCH occasion (assumed to be the indicated used CG PUSCH occasion), none of the CG PUSCH occasions before it is required to use. In some embodiments, from the starting unused CG PUSCH occasion to a certain CG PUSCH occasion (assumed to be the indicated unused CG PUSCH occasion), none of the CG PUSCH occasions covered/involved is required to use. In some embodiments, M (>=0) CG PUSCH occasions starting from the starting unused CG PUSCH occasion are not needed (that is, are unused CG PUSCH occasion(s)).

In the embodiments of this application, the UE indicates information corresponding to unused CG PUSCH occasion(s) after completing the transmission of the current higher-layer service data, that is, the UE can send the indication as long as it determines the unused CG PUSCH occasions (possibly before or after the actual data transmission operation, which is not restricted).

The second information is used to indicate any one of the following:
(1) starting from the 1st unused CG PUSCH occasion, none of CG PUSCH occasions before a first CG PUSCH occasion (which is denoted as indicated unused CG PUSCH occasion) is required to use, where it should be noted that the unused CG PUSCH occasion indicated in (1) does not include the “first CG PUSCH occasion”;
(2) from the 1st unused CG PUSCH occasion to a second CG PUSCH occasion, none of CG PUSCH occasions covered or involved is required to use, where it should be noted that the unused CG PUSCH occasion indicated in (2) includes the “first CG PUSCH occasion”; or
(3) none of M CG PUSCH occasions starting from the 1st unused CG PUSCH occasion is required to use, where M is a positive integer, where
the 1st unused CG PUSCH occasion is explicitly indicated by the terminal in UCI, or the 1st unused CG PUSCH occasion is implicitly determined based on a UCI transmission status.

Referring to the application scenario shown in FIG. 3b, the video frame corresponds to 60 FPS, and the serving cell adopts a conventional DDDSU as the TDD pattern (time division duplex pattern). To ensure that the configured CG PUSCH occasions are actually available, in a case of determining the CG configuration parameters (that is, the configuration parameters corresponding to the CG Config), it can be ensured that each CG PUSCH occasion corresponds to the uplink time unit in the TDD pattern. In addition, in a case that multiple CG PUSCH occasions can be configured within a single period of a single CG Config, considering that the video frame corresponds to a non-integer periodicity, which does not closely match the period values that can be configured for the CG Config, suitable CG resource can be configured for the video frame by configuring multiple CG Configs. In FIG. 3b, three CG Configs are configured, each CG Config has a period of 50 ms, and reasonable offset configurations ensure that the CG PUSCH occasion(s) configured within a single period of each CG Config align as closely as possible with the expected arrival time of the corresponding video frame. In FIG. 3b, each CG Config configures three CG PUSCH occasions within a single period, and CG PUSCH occasions corresponding to different CG Configs are distinguished by different fill patterns. It should be noted that FIG. 3b illustrates only a scenario where an occasion set includes three CG PUSCH occasions. This application does not specifically limit the number of CG PUSCH occasions included in an occasion set, nor does it limit whether the CG PUSCH occasions included in each occasion set correspond to the same or different CG Configs.

The UE may indicate that from the starting unused CG PUSCH occasion to a certain CG PUSCH occasion (assumed to be the indicated used CG PUSCH occasion), none of the CG PUSCH occasions before it is required to use. In some embodiments, from the starting unused CG PUSCH occasion to a certain CG PUSCH occasion (assumed to be the indicated unused CG PUSCH occasion), none of the CG PUSCH occasions covered/involved is required to use. In some embodiments, M (>=0) CG PUSCH occasions starting from the starting unused CG PUSCH occasion are not needed (that is, are unused CG PUSCH occasion(s)).

The network-side device considers that for any CG PUSCH occasion starting from the indicated used CG PUSCH occasion (or from the CG PUSCH occasion following the indicated unused CG PUSCH occasion), the UE may use it, and the first or starting CG PUSCH occasion actually put into use (see the description of the first used CG PUSCH occasion) can be further determined from CG PUSCH occasion(s) starting from the indicated used CG PUSCH occasion (or from the CG PUSCH occasion following the indicated unused CG PUSCH occasion) based on the description above.

The starting unused CG PUSCH occasion can be determined by any one of the following manners (1) and (2):
(1) Being explicitly indicated by the UE in UCI in any one of the following manners (a) and (b):
(a) directly indicating a position or index of the starting unused CG PUSCH occasion; or
(b) for an actually used CG PUSCH occasion, the UE (by using 1 bit) indicates whether it is the last used CG PUSCH occasion (see the description above), and a CG PUSCH occasion following the last used CG PUSCH occasion is the starting unused CG PUSCH occasion.
(2) Being implicitly determined, for example, taking the CG PUSCH occasion following the last used CG PUSCH occasion indicated in the same UCI (corresponding to the same window) as the starting unused CG PUSCH occasion.

For the M unused CG PUSCH occasion(s) starting from the starting unused CG PUSCH occasion, the UE can indicate the value M in the UCI.

For the indicated used CG PUSCH occasion or indicated unused CG PUSCH occasion, the UE can indicate its position or index in the UCI.

In a case that the number of the unused CG PUSCH occasions indicated by the UE is actually 0, the UE indicates a default value or reserved value when indicating the position or index of the starting unused CG PUSCH occasion, or indicates the value M=0, or indicates a default value or reserved value when indicating the position or index of the indicated used CG PUSCH occasion or indicated unused CG PUSCH occasion.

Indication manner 1-2: The information corresponding to used/unused CG PUSCH occasion(s) includes: the time period(s) corresponding to the used/unused CG PUSCH occasion(s), including the starting time, or ending time, or duration of the time period.

In an embodiment, the first information includes at least one of the following:
(1) starting times of the time period corresponding to the used CG PUSCH occasions,
(2) ending times of the time period corresponding to the used CG PUSCH occasions, or
(3) a duration of the time period corresponding to the used CG PUSCH occasions; and
the second information includes at least one of the following:
(1) starting times of the time period corresponding to the unused CG PUSCH occasions,
(2) ending times of the time period corresponding to the unused CG PUSCH occasions, or
(3) a duration of the time period corresponding to the unused CG PUSCH occasions.

The time or duration here can be indicated in system time-domain unit (slot, symbol, or the like) or absolute time unit (ms or the like).

When indicated in system time-domain unit, if the CG PUSCH occasions come from multiple uplink carriers, and the subcarrier spacings (Subcarrier Spacing, SCS) (μ) applied to the active uplink bandwidth part (active UL BWP) of these carriers are not completely identical, the length/numbering of the system time-domain unit can be determined based on a reference SCS (μ), and the time or duration can be indicated accordingly. The reference SCS (μ) can be any one of the following:
(a) an SCS (μ) configured by higher-layer signaling or specified by the protocol;
(b) an SCS (μ) corresponding to the CG PUSCH occasion carrying the indication information; or
(c) a minimum/maximum value of SCSs (μ) applied to all carriers configured or activated with CG Config.

For (c), any CG Config here is required to meet at least one of the condition items listed for CG Config (see the description in the section on predefined conditions that CG PUSCH occasions need to satisfy).

Accordingly, in a case that the UE indicates the time period(s) corresponding to used CG PUSCH occasion(s):
the starting time of the time period can be the starting/ending time of the first used CG PUSCH occasion (for its determination, reference can be made to the corresponding description in indication manner 1-1, in some cases, it needs to be explicitly indicated, and in other case, it does not need to be explicitly indicated).

The UE indicates the ending time or duration. In some embodiments, in a case that the UE does not indicate the ending time or duration, or indicates a special value for the ending time or duration, it can be considered that the usage duration extends to a predefined time, such as the expected arrival time of the next higher-layer service data (for example, the next video frame) (in a case that there is no jitter) or (expected arrival time −X) (in a case that there is jitter).

It can be understood that in a case that the starting/ending time of a CG PUSCH occasion is earlier than/not later than the ending time, or the time corresponding to the duration, this CG PUSCH occasion is considered a used CG PUSCH occasion.

Accordingly, in a case that the UE indicates the time period(s) corresponding to unused CG PUSCH occasion(s): the indication manner is similar to the indication of information corresponding to unused CG PUSCH occasion(s) in indication manner 1-1, only replacing the position (index) of the CG PUSCH occasion with time, or replacing the number of CG PUSCH occasions with duration.

In some embodiments, the UE may indicate that from the (start/end) time corresponding to the starting unused CG PUSCH occasion (for its determination, reference can be made to the corresponding description in indication manner 1-1; and it may be explicitly indicated or implicitly determined) to the indicated ending time, none of the CG PUSCH occasions within this time range is required to use. In some embodiments, from the (start/end) time corresponding to the starting unused CG PUSCH occasion, none of the CG PUSCH occasions within the indicated duration is required to use.

The network-side device considers that for any CG PUSCH occasion located after the ending time or the time corresponding to the duration, the UE may use it, and the first or starting CG PUSCH occasion actually put into use (see the description of the first used CG PUSCH occasion) can be further determined based on the description above.

The UE indicates the ending time or duration. In some embodiments, in a case that the UE does not indicate the ending time or duration, or indicates a special value for the ending time or duration, it can be considered that the usage duration extends to a predefined time, such as the expected arrival time of the next higher-layer service data (for example, the next video frame) (in a case that there is no jitter) or (expected arrival time −X) (in a case that there is jitter).

Indication manner 2: The UE indicates the unused/required-to-use state of each CG PUSCH occasion within a certain time range.

In an embodiment, the sending, by a terminal, first indication information to a network-side device includes:
indicating, by the terminal, to the network-side device a not-required-to-use state or a required-to-use state of each CG PUSCH occasion within a first time period.

For the indicated information, any one of the following manners can be used:
information indication manner 1: The UE explicitly indicates the unused/required-to-use state of each CG PUSCH occasion using a bitmap.

In an embodiment, the indicating, by the terminal, to the network-side device a not-required-to-use state or a required-to-use state of each CG PUSCH occasion within a first time period includes:
indicating, by the terminal, the not-required-to-use state or the required-to-use state of each CG PUSCH occasion within the first time period using a bitmap.

For example, each bit in the bitmap indicates whether the corresponding CG PUSCH occasion (or the CG PUSCH occasion(s) involved in the window on the corresponding serving cell, or the CG PUSCH occasion(s) corresponding to the CG Config in the window) is used (meaning having been used or requiring to use, for example, the value is 0) or unused (meaning having not been used or not requiring to use, for example, the value is 1).

An indication granularity of the bitmap is any one of the following:
(1) a granularity of CG PUSCH occasion,
(2) a granularity of serving cell, or
(3) a granularity of CG Config.

The length of the bitmap can be determined in any one of the following manners (1) and (2):
(1) Being explicitly configured by higher-layer signaling.

For example, RRC signaling is used to configure the number of bits corresponding to the bitmap.

In some embodiments, the UE does not expect the length of the bitmap to be shorter/fewer than the number of CG PUSCH occasions involved in any indication period, or the number of serving cells involved in the CG PUSCH occasions in any indication period (assumed to be the number to be indicated), or the number of CG Configs involved in the CG PUSCH occasions in any indication period (assumed to be the number to be indicated). For a certain indication period, in a case that the length of the bitmap is longer/more than the number to be indicated, the UE only uses the bits in the bitmap corresponding to the number to be indicated at the front or tail, and the remaining bits can be ignored (for example, set to reserved values or arbitrary values), or used to indicate resource status information corresponding to the next (in a case that the current indication period corresponds to the bits at the front of the bitmap)/previous (in a case that the current indication period corresponds to the bits at the tail of the bitmap) indication period.
(2) Being implicitly determined based on the number of CG PUSCH occasions involved in the indication period, based on the number of serving cells involved in the CG PUSCH occasions, or based on the number of CG Configs involved in the CG PUSCH occasions.

For the determination of the indication period, reference is made to the corresponding description below.

The terminal and the network side can semi-statically determine the number of CG PUSCH occasions involved in the indication period based on the CG Config configuration, indication period configuration, or the like.

In a case that the length of the bitmap is the number of CG PUSCH occasions involved in the indication period:
in this case, it is assumed that the granularity of resource status indication is a single CG PUSCH occasion.

In a case that the length of the bitmap is the number of serving cells involved in the CG PUSCH occasions in the indication period:
in this case, it is assumed that the granularity of resource status indication is a single serving cell, or all CG PUSCH occasion(s) corresponding to this serving cell in the indication period.

In a case that the length of the bitmap is the number of CG Configs involved in the CG PUSCH occasions in the indication period, in this case, it is assumed that the granularity of resource status indication is a single CG Config, or all CG PUSCH occasion(s) corresponding to this CG Config in the indication period.

Information indication manner 2: Assuming that when the UE needs to use the CG resource, it always occupies consecutive CG PUSCH occasion(s) in terms of position (index), the UE indicates information corresponding to used CG PUSCH occasion(s) in a corresponding indication period, or and information corresponding to unused CG PUSCH occasion(s).

The indication can be any one of the following cases:
case I: the UE indicates only information corresponding to used CG PUSCH occasion(s) in the corresponding indication period;
case II: the UE indicates only information corresponding to unused CG PUSCH occasion(s) in the corresponding indication period; or
case III: the UE indicates both information corresponding to used CG PUSCH occasion(s) and information corresponding to unused CG PUSCH occasion(s) in the corresponding indication period.

Here, it is assumed that in the corresponding indication period, the used CG PUSCH occasion(s) and unused CG PUSCH occasion(s) determined by the UE appear sequentially, that is, at least one used CG PUSCH occasion is followed by zero/one/multiple unused CG PUSCH occasions (there may be a gap between any two adjacent CG PUSCH occasions, determined based on the TDD pattern). The at least one used CG PUSCH occasion and the subsequent zero/one/multiple unused CG PUSCH occasions can constitute a window (that is, the time-domain window corresponding to the indication information, involving one or more CG PUSCH occasions within the window).

In a case that there is no missed detection of CG PUSCH occasion/UCI:
for case III, the window (its starting position and ending position) can be fully determined based on the indication information. Generally, the window is entirely located within the corresponding indication period, and in some embodiments, the ending position of the window may be located in the next indication period, but there is no overlapping between the windows corresponding to these two indication periods.

For case I, the starting position of the window can be determined by the information corresponding to the indicated used CG PUSCH occasion(s). The ending position of the window is undefined, or determined by the ending time of the corresponding indication period (for example, a CG PUSCH occasion whose starting/ending time is not later than the ending time of the corresponding indication period (in a case that the granularity of the window is CG PUSCH occasion), or the starting/ending time of this CG PUSCH occasion (in a case that the granularity of the window is absolute time or time-domain unit)).

For case II, the starting position of the window can be determined by the first used CG PUSCH occasion (see the corresponding description above); and the ending position of the window can be determined by the information corresponding to the indicated unused CG PUSCH occasion(s).

Information indication manner 2-1: The information corresponding to used/unused CG PUSCH occasion(s) includes: the starting position (index), and/or ending position (index), or the number of used/unused CG PUSCH occasion(s).

In an embodiment, the first information includes at least one of the following:
(1) a starting position or starting index of the used CG PUSCH occasions,
(2) an ending position or ending index of the used CG PUSCH occasions, and
(3) the number of the used CG PUSCH occasions; or
the second information includes at least one of the following:
(1) a starting position or starting index of the unused CG PUSCH occasions,
(2) an ending position or ending index of the unused CG PUSCH occasions, or
(3) the number of the unused CG PUSCH occasions.

It can be understood that in indicating the position or index of a CG PUSCH occasion, at least one of the following may be indicated to identify this CG PUSCH occasion:
(1) a starting/ending time of the CG PUSCH occasion, where the time may be indicated in terms of system time-domain unit (radio frame, slot, symbol, or the like) or absolute time unit (ms or the like); and only a local index of the system time-domain unit/absolute time unit within the corresponding indication period may be indicated (indexing may start from 0 or 1);
(2) an index of a serving cell where the CG PUSCH occasion is located/corresponds to;
(3) a Config index of the CG Config corresponding to the CG PUSCH occasion;
(4) a local index of a CG PUSCH occasion among CG PUSCH occasion(s) existing within the corresponding indication period for the corresponding CG Config (indexing may start from 0 or 1); and
(5) a local index of a CG PUSCH occasion among all CG PUSCH occasion(s) configured for the UE/higher-layer service within the corresponding indication period (indexing may start from 0 or 1).

In a case that the UE indicates the information corresponding to used CG PUSCH occasion(s), reference can be made to the corresponding description in indication manner 1-1. In this case, the first used CG PUSCH occasion is further restricted to be within the corresponding indication period.

In a case that the UE indicates the information corresponding to unused CG PUSCH occasion(s), reference can be made to the corresponding description in indication manner 1-1.

Information indication manner 2-2: The information corresponding to used/unused CG PUSCH occasion(s) includes: the time period corresponding to used/unused CG PUSCH occasion(s), including the starting time, and/or ending time, or duration of the time period.

In an embodiment, the first information includes at least one of the following:
(1) starting times of the time period corresponding to the used CG PUSCH occasions,
(2) ending times of the time period corresponding to the used CG PUSCH occasions, or
(3) a duration of the time period corresponding to the used CG PUSCH occasions; and
the second information includes at least one of the following:
(1) starting times of the time period corresponding to the unused CG PUSCH occasions,
(2) ending times of the time period corresponding to the unused CG PUSCH occasions, or
(3) a duration of the time period corresponding to the unused CG PUSCH occasions.

The time or duration here can be indicated in system time-domain unit (slot, symbol, or the like) or absolute time unit (ms or the like). When indicated in system time-domain unit, for the determination of the reference SCS (μ), reference can be made to the description above.

In a case of indicating the time, only the local index of the system time-domain unit or absolute time unit within the corresponding indication period may be indicated (indexing may start from 0 or 1).

Accordingly, in a case that the UE indicates the time period(s) corresponding to used CG PUSCH occasion(s):
the starting time of the time period can be the starting/ending time of the first used CG PUSCH occasion (for its determination, reference can be made to the corresponding description in indication manner 1-1.

The UE indicates the ending time or duration, where in a case that no indication is made or a special value is indicated, it can be considered that the usage duration extends to a predefined time, such as the ending time of the corresponding indication period.

It can be understood that in a case that the starting/ending time of a CG PUSCH occasion is earlier than/not later than the ending time, or the time corresponding to the duration, this CG PUSCH occasion is considered a used CG PUSCH occasion.

Accordingly, in a case that the UE indicates the time period(s) corresponding to unused CG PUSCH occasion(s):
the UE may indicate that from the (start/end) time corresponding to the starting unused CG PUSCH occasion (for its determination, reference can be made to the corresponding description in indication manner 1-1) to the indicated ending time, none of the CG PUSCH occasions within this time range is required to use. In some embodiments, from the (start/end) time corresponding to the starting unused CG PUSCH occasion, none of the CG PUSCH occasions within the indicated duration is required to use.

The network side considers that for any CG PUSCH occasion located after the ending time or the time corresponding to the duration, the UE may use it, and the first or starting CG PUSCH occasion actually put into use (see the description of the first used CG PUSCH occasion) can be further determined based on the description above.

The UE indicates the ending time or duration, where in a case that no indication is made or a special value is indicated, it can be considered that the usage duration extends to a predefined time, such as the ending time of the corresponding indication period.

Information indication manner 3: Assuming that when the UE needs to use CG resource, it always occupies consecutive CG PUSCH occasion(s) in terms of position (index), the UE (using 1 bit) indicates whether a used CG PUSCH occasion is the last used CG PUSCH occasion.

In an embodiment, the sending, by the terminal, to the network-side device the not-required-to-use state or the required-to-use state of each CG PUSCH occasion within a first time period includes:
indicating, by the terminal, to the network-side device whether a specified used CG PUSCH occasion within the first time period is the last used CG PUSCH occasion.

This indication can also be understood as: indicating whether, starting from the next CG PUSCH occasion, the remaining CG PUSCH occasions within the corresponding indication period are all unused CG PUSCH occasions.

It should be noted that this indication manner is actually included in information indication manner 2 (corresponding to case I and information indication manner 2-1, where the UE indicates the last used CG PUSCH occasion (within the corresponding indication period), and for an actually used CG PUSCH occasion, the UE (by using 1 bit) indicates whether it is the last used CG PUSCH occasion). It is listed separately here for a more intuitive representation of this indication manner.

For indicated transmission, in an embodiment, the first indication information is carried by a CG PUSCH, or the first indication information is carried by a periodic PUCCH or a periodic PUSCH, or the first indication information is carried by a semi-persistent PUCCH or a semi-persistent PUSCH; and
an indication period of the first indication information is determined in any one of the following manners:
(1) being explicitly configured by higher-layer signaling,
(2) being determined based on a period of a TDD frame structure, or
(3) being determined based on a period of the service data.

Generally, the indication information mentioned above can be carried on CG PUSCH, for example, carried on the CG PUSCH occasion actually occupied/transmitted by the UE. In some embodiments, it can be carried by periodic/semi-persistent PUCCH/PUSCH.

The indication period (including period length and offset) mentioned above can be determined by any one of the following manners:

(1) being Explicitly Configured by Higher-Layer Signaling.

For example, RRC signaling is used to configure the period length and offset corresponding to the periodic/semi-persistent PUCCH/PUSCH transmission, measured in system time-domain unit (slot, symbol, or the like) or absolute time unit (ms or the like). When indicated in system time-domain unit, for the determination of the reference SCS (μ), reference can be made to the description above.

### (2) Determined Based on the TDD Pattern (TDD Frame Structure) Period

The period length can be directly the period of the TDD pattern, or N times the period of the TDD pattern, where N is a positive integer, which can be specified by the protocol or configured by higher-layer signaling. The offset relative to the TDD pattern can be 0 or no offset, that is, the starting time of the indication period aligns with the starting time of a certain TDD pattern. It can also be explicitly configured additionally or specified by the protocol.

### (3) Determined Based on the Period of the Higher-Layer Service

For example, for video frames of XR services, the period of the higher-layer service is 1/FPS. The indication period length can be directly the period of the higher-layer service, or M times the period of the higher-layer service, where M is a positive integer, which can be specified by the protocol or configured by higher-layer signaling. The offset relative to the expected arrival time of the higher-layer service can be 0 or no offset, that is, the starting time of the indication period aligns with the expected arrival time of a certain video frame. It can also be explicitly configured additionally or specified by the protocol, for example, the offset here can consider the latency required for the UE to use the configured CG PUSCH occasions to carry higher-layer service data and initiate the corresponding CG PUSCH transmission after the arrival of the higher-layer service data.

In an embodiment, for indication manner 1 and indication manner 2, the time interval between the first UCI carrying the first indication information and the earliest unused CG PUSCH occasion corresponding to the first indication information is not less than a first duration. A starting time of the time interval is an ending time of a PUCCH or PUSCH carrying UCI, an ending time of the time interval is a starting time of the earliest unused CG PUSCH occasion corresponding to the first indication information, and the first UCI is one of earliest A pieces of UCI indicating the earliest unused CG PUSCH occasion, where A is a positive integer.

In the embodiments of this application, for indication manner 1 and indication manner 2, a predefined timeline requirement is introduced, that is, the time interval between the UCI transmission carrying the indication information (this indication information being one of the earliest A pieces of indication information indicating a given CG PUSCH occasion as unused. The A pieces of indication information correspond one-to-one with A UCI transmissions carrying the indication information) and the given CG PUSCH occasion is required to be greater than or not less than a predefined duration Min_Time. In some embodiments, the value of A is 1. It is required that any unused CG PUSCH occasion indicated and the UCI transmission corresponding to the earliest A pieces of indication information indicating it as unused satisfy this predefined timeline requirement. The time interval here may have a starting time as the ending time (or the last symbol) of the PUCCH/PUSCH carrying the UCI and an ending time as the starting time (or the first symbol) of the earliest unused CG PUSCH occasion corresponding to the indication information. The Min_Time here mainly considers the minimum duration required for the network side to successfully decode the resource recycling information and allocate the time-frequency resources corresponding to the unused CG PUSCH occasion for other purposes (for example, retransmission) or other UEs.

For indication manner 1, the indication information may be carried in each used CG PUSCH occasion, in which case the 1st unused CG PUSCH occasion indicated by the indication information carried in each used CG PUSCH occasion within the same window is required to be the same (this indication may be referred to as consistent indication), and at least the indication information carried by the 1st used CG PUSCH occasion within the window (or indication information carried by a used CG PUSCH occasion that is the first to carry indication information) and the 1st unused CG PUSCH occasion indicated must satisfy the predefined timeline requirement mentioned above. In some embodiments, for a certain CG PUSCH occasion, if the indication information carried by a previous used CG PUSCH occasion within the same window has already indicated it as an unused CG PUSCH occasion, the indication information carried by a later used CG PUSCH occasion cannot indicate it as a used CG PUSCH occasion. However, the reverse (Used->Unused, that is, for a CG PUSCH occasion indicated by indication information as used, subsequent indication information can change the status of the CG PUSCH occasion from used to unused) is allowed (this situation may be referred to as updated indication). In a case that updated indication is allowed, the updated indication information and the 1st CG PUSCH occasion updated by this indication information (Used->Unused) must also satisfy the predefined timeline requirement mentioned above.

In some embodiments, the indication information may be carried only in a single or a few (not every) used CG PUSCH occasions within a certain window. In this case, for the single or each used CG PUSCH occasion carrying the indication information within the same window, the predefined timeline requirement is applied based on the rules described above.

For indication manner 2, any one of the following manners (1) and (2) can be adopted:
(1) Introduce an indication restriction:
(1.1) For information indication manner 1,
(a) in a case that the indication information is carried by periodic/semi-persistent PUCCH/PUSCH (generally, it is assumed here that only one indication information is sent within a single indication period), CG PUSCH occasions that do not satisfy the predefined timeline requirement mentioned above with the UCI transmission corresponding to the indication information are not allowed to be indicated as unused CG PUSCH occasions, or the indication status corresponding to these CG PUSCH occasions is ignored. In some embodiments, when the length of the bitmap is implicitly determined, it can be assumed that CG PUSCH occasions that do not satisfy the predefined timeline requirement mentioned above do not exist (that is, there is no need to set indication bits corresponding to them in the bitmap; and this assumption only affects the setting of the bitmap and does not affect the use of CG PUSCH occasions). For example, in a case that the length of the bitmap is the number of CG PUSCH occasions involved in the indication period, these CG PUSCH occasions that do not satisfy the predefined timeline requirement are excluded in a case of determining the number of CG PUSCH occasions, and the one-to-one mapping relationship between each bit in the bitmap and the CG PUSCH occasions that satisfy the predefined timeline requirement is determined accordingly.
(b) In a case that the indication information is carried by used CG PUSCH occasions, it is handled similarly to indication manner 1: the predefined timeline requirement mentioned above can be applied based on a used CG PUSCH occasion that is the first to carry the indication information within the indication period (that is, at least the indication information carried by the used CG PUSCH occasion that is the first to carry the indication information within the indication period and the 1st unused CG PUSCH occasion indicated must satisfy the predefined timeline requirement mentioned above). In a case that updated indication is allowed, the updated indication information and the 1st CG PUSCH occasion updated by this indication information (Used->Unused) must also satisfy the predefined timeline requirement mentioned above.
(1.2) For information indication manner 2, generally, the indication information is carried by used CG PUSCH occasions, and it is handled similarly to indication manner 1 in this case: the predefined timeline requirement mentioned above can be applied based on a used CG PUSCH occasion that is the first to carry the indication information within the indication period (that is, at least the indication information carried by the used CG PUSCH occasion that is the first to carry the indication information within the indication period and the 1st unused CG PUSCH occasion indicated must satisfy the predefined timeline requirement mentioned above). In a case that updated indication is allowed, the updated indication information and the 1 st CG PUSCH occasion updated by this indication information (Used->Unused) must also satisfy the predefined timeline requirement mentioned above.
(1.3) For information indication manner 3, the indication bit is applied to the CG PUSCH occasion following the used CG PUSCH occasion carrying the indication information. In this case, for a used CG PUSCH occasion carrying the indication information, its next CG PUSCH occasion can be indicated as unused only when the next CG PUSCH occasion satisfies the predefined timeline requirement mentioned above.
(2) Distinguish between two types of periods: transmission period and indication period:

The transmission period is used to determine the transmission of the indication information, while the indication period is used to determine the content of the indication information. The transmission period corresponds one-to-one with the indication period. The transmission period and the indication period have the same length, but there is a certain time-domain offset (Time_Offset) between a transmission period and its corresponding indication period (that is, the indication period lags behind the corresponding transmission period by Time_Offset), which is specified by the protocol or configured by higher-layer signaling and satisfies the predefined timeline requirement mentioned above. The indication information transmitted within the transmission period is determined based on the resource occupancy/recycling situation within the corresponding indication period. An example is shown in FIG. 3c.

In an embodiment, the number of the used CG PUSCH occasions indicated by the first indication information is any one of the following, so as to indicate to the network-side device that an additional uplink transmission resource is required:
(1) a reserved value; or
(2) a value greater than the number of preconfigured CG PUSCH occasions.

In the embodiments of this application, for any indication manner indicating the number of the used CG PUSCH occasions (for example, indication manner 1-1 or information indication manner 2 of indication manner 2). In some embodiments, the UE can indicate, by indicating the number of the used CG PUSCH occasions being greater than the number of configured CG PUSCH occasions (or indicating a reserved value), to the network side that additional uplink resources are needed for carrying the higher-layer service data beyond the currently configured CG PUSCH occasion.

In some embodiments, in this case, the excess number (that is, the number of the used CG PUSCH occasions minus the number of configured CG PUSCH occasions) can be used by the UE to roughly indicate the amount of additional uplink resources needed to the network side (combined with the (average) TB size corresponding to the configured CG PUSCH occasions, or the like).

In an embodiment, the number of the unused CG PUSCH occasions indicated by the first indication information is any one of the following, so as to indicate to the network-side device that an additional uplink transmission resource is required:
(1) a reserved value; or
(2) a negative value.

In some embodiments, for any indication manner indicating the number of the unused CG PUSCH occasions (for example, indication manner 1-1 or information indication manner 2 of indication manner 2), the UE can indicate, by indicating a reserved value or indicating a negative value, to the network side that additional uplink resources are needed for carrying the higher-layer service data beyond the currently configured CG PUSCH occasion. In some embodiments, in this case, the negative value indicates “further needed,” and the absolute value of the negative value is the number of further needed CG PUSCH occasions. The number corresponding to the absolute value of the negative value can be used by the UE to roughly indicate to the network side the amount of additional uplink resources needed (combined with the (average) TB size corresponding to the configured CG PUSCH occasions, or the like).

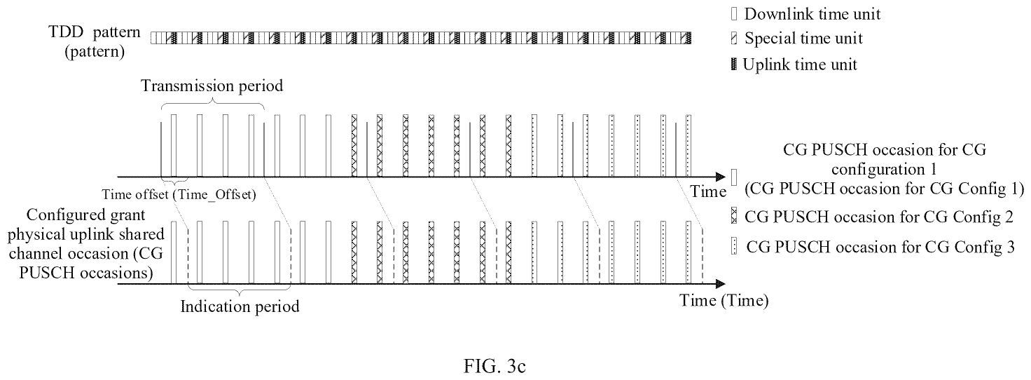

Referring to FIG. 4, an embodiment of this application provides an indication method, the method is executed by a network-side device, and the method includes:

Step 401: The network-side device receives first indication information from a terminal during a duration of service data or in a case that a CG resource is present.

Step 402: The network-side device reallocates a time-frequency resource corresponding to unused CG PUSCH occasions based on the first indication information. It can be understood that the embodiments of this application do not specifically limit how the time-frequency resources corresponding to the CG PUSCH occasion are allocated or for what purposes they are used.

The CG resource includes at least one configured grant physical uplink shared channel occasion CG PUSCH occasion, the first indication information is used to indicate positions or indexes of used CG PUSCH occasions and positions or indexes of unused CG PUSCH occasions in the CG resource, or the first indication information is used to indicate a time period corresponding to used CG PUSCH occasions and a time period corresponding to unused CG PUSCH occasions in the CG resource, or the first indication information is used to indicate used CG PUSCH occasions and/or unused CG PUSCH occasions in the CG resource within a first time period.

The CG PUSCH occasion is determined to support resource recycling, and in some embodiments, based on a preset rule (for example, the protocol directly specifies that CG PUSCH occasions used to carry a certain type of service all support resource recycling) or configuration signaling, the CG PUSCH occasion is determined to support resource recycling.

In the embodiments of this application, during the duration of the service data or in a case that the CG resource is present, the terminal indicates to the network-side device the positions or indexes of the used CG PUSCH occasions and the positions or indexes of the unused CG PUSCH occasions in the CG resource, indicates the time period corresponding to the used CG PUSCH occasions and the time period corresponding to the unused CG PUSCH occasions in the CG resource, or indicates the used CG PUSCH occasions or the unused CG PUSCH occasions in the CG resource within the first time period. This enables the terminal to continuously indicate the usage status of CG PUSCH occasions to the network-side device during the duration of the service data or in a case that the CG resource is present, thereby effectively improving resource utilization efficiency and capacity performance in serving higher-layer service data based on CG resources.

The network-side method corresponds to the terminal-side method, and for related content below, reference can be made to the relevant description of the terminal side, which will not be repeated here.

In an embodiment, the receiving, by a network-side device, first indication information from a terminal includes:
receiving, by the network-side device, from the terminal first information corresponding to the used CG PUSCH occasions and second information corresponding to the unused CG PUSCH occasions.

In an embodiment, the receiving, by a network-side device, first indication information from a terminal includes:
receiving, by the network-side device, a not-required-to-use state or a required-to-use state of each CG PUSCH occasion within the first time period that are indicated by the terminal.

In an embodiment, the receiving, by the network-side device, a not-required-to-use state or a required-to-use state of each CG PUSCH occasion within the first time period that are indicated by the terminal includes:
receiving, by the network-side device, a not-required-to-use state or a required-to-use state of each CG PUSCH occasion within the first time period that are indicated by the terminal by using a bitmap; where
an indication granularity of the bitmap is any one of the following:
a granularity of CG PUSCH occasion,
a granularity of serving cell, or
a granularity of CG Config.

In an embodiment, the receiving, by the network-side device, a not-required-to-use state or a required-to-use state of each CG PUSCH occasion within the first time period that are indicated by the terminal includes:
receiving, by the network-side device, first information corresponding to the used CG PUSCH occasions or second information corresponding to the unused CG PUSCH occasions within a preset indication period that are indicated by the terminal.

In an embodiment, the first information is used to indicate any one of the following:
N used CG PUSCH occasions starting from the 1st used CG PUSCH occasion, where N is a positive integer, or
all used CG PUSCH occasions from the 1st used CG PUSCH occasion to the last used CG PUSCH occasion; and
the second information is used to indicate any one of the following:
starting from the 1st unused CG PUSCH occasion, none of CG PUSCH occasions before a first CG PUSCH occasion is required to use,
from the 1st unused CG PUSCH occasion to a second CG PUSCH occasion, none of CG PUSCH occasions covered or involved is required to use, or
none of M CG PUSCH occasions starting from the 1st unused CG PUSCH occasion is required to use, where M is a positive integer, where
the 1st used CG PUSCH occasion is any one of the following:
the 1st CG PUSCH occasion carrying the service data,
the 1st CG PUSCH occasion carrying uplink control information UCI corresponding to the first indication information,
the 1st CG PUSCH occasion actually occupied or transmitted by the terminal, or
a CG PUSCH occasion following the last CG PUSCH occasion indicated by a previous window, where the window is a window corresponding toof the first indication information in time domain, and the window includes at least one used CG PUSCH occasion, or the window includes at least one used CG PUSCH occasion and at least one unused CG PUSCH occasion; where
the 1st unused CG PUSCH occasion is explicitly indicated by the terminal in the uplink control information UCI, or the 1st unused CG PUSCH occasion is implicitly determined based on the last used CG PUSCH occasion.

In an embodiment, the first information includes at least one of the following:
a starting position or starting index of the used CG PUSCH occasions,
an ending position or ending index of the used CG PUSCH occasions, or
the number of the used CG PUSCH occasions; and
the second information includes at least one of the following:
a starting position or starting index of the unused CG PUSCH occasions,
an ending position or ending index of the unused CG PUSCH occasions, or
the number of the unused CG PUSCH occasions.

In an embodiment, the first information includes at least one of the following:
starting times of the time period corresponding to the used CG PUSCH occasions,
ending times of the time period corresponding to the used CG PUSCH occasions, or
a duration of the time period corresponding to the used CG PUSCH occasions; and
the second information includes at least one of the following:
starting times of the time period corresponding to the unused CG PUSCH occasions,
ending times of the time period corresponding to the unused CG PUSCH occasions, or
a duration of the time period corresponding to the unused CG PUSCH occasions.

In an embodiment, the receiving, by the network-side device, a not-required-to-use state or a required-to-use state of each CG PUSCH occasion within the first time period that are indicated by the terminal includes:
receiving, by the network-side device, an indication indicated by the terminal whether a specified used CG PUSCH occasion within the first time period is the last used CG PUSCH occasion.

In an embodiment, the first indication information is carried by a CG PUSCH, or the first indication information is carried by a periodic PUCCH or a periodic PUSCH, or the first indication information is carried by a semi-persistent PUCCH or a semi-persistent PUSCH; and
an indication period of the first indication information is determined in any one of the following manners:
being explicitly configured by higher-layer signaling,
being determined based on a period of a TDD frame structure, or
being determined based on a period of the service data.

In an embodiment, a time interval between first UCI carrying the first indication information and an earliest unused CG PUSCH occasion corresponding to the first indication information is not less than a first duration; where
a starting time of the time interval is an ending time of a PUCCH or PUSCH carrying UCI, an ending time of the time interval is a starting time of the earliest unused CG PUSCH occasion corresponding to the first indication information, and the first UCI is one of earliest A pieces of UCI indicating the earliest unused CG PUSCH occasion, where A is a positive integer.

In an embodiment, the number of the used CG PUSCH occasions indicated by the first indication information is any one of the following, so as to indicate to the network-side device that an additional uplink transmission resource is required:
a reserved value; or
a value greater than the number of preconfigured CG PUSCH occasions.

In an embodiment, the number of the unused CG PUSCH occasions indicated by the first indication information is any one of the following, so as to indicate to the network-side device that an additional uplink transmission resource is required:
a reserved value; or
a negative value.

The indication method provided in the embodiments of this application can be executed by an indication apparatus. In the embodiments of this application, the indication apparatus performing the indication method is used to describe the indication apparatus provided in the embodiments of this application.

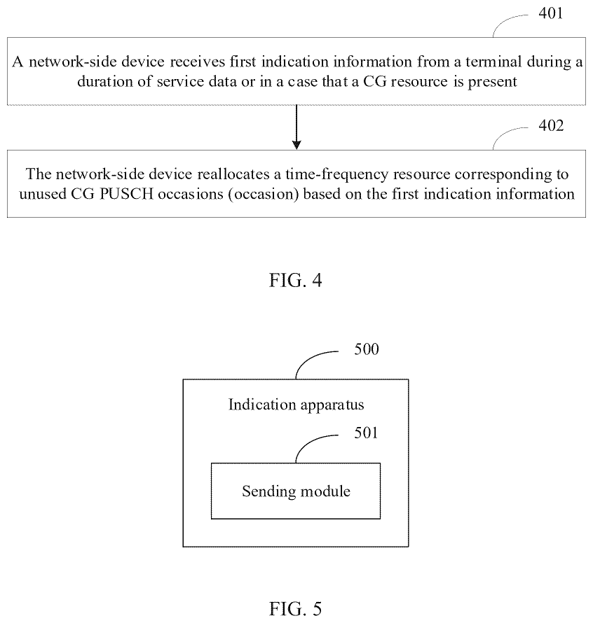

Referring to FIG. 5, an embodiment of this application provides an indication apparatus 500, the apparatus is applied to a terminal, and the apparatus includes:
a sending module 501 configured for the terminal to send first indication information to a network-side device during a duration of service data or in a case that a CG resource is present; where
the CG resource includes at least one configured grant physical uplink shared channel occasion CG PUSCH occasion, the first indication information is used to indicate positions or indexes of used CG PUSCH occasions and positions or indexes of unused CG PUSCH occasions in the CG resource, or the first indication information is used to indicate a time period corresponding to used CG PUSCH occasions and a time period corresponding to unused CG PUSCH occasions in the CG resource, or the first indication information is used to indicate used CG PUSCH occasions and/or unused CG PUSCH occasions in the CG resource within a first time period; and
the CG PUSCH occasion is determined to support resource recycling.

In some embodiments, the sending module is further configured for
the terminal to send to the network-side device first information corresponding to the used CG PUSCH occasions and second information corresponding to the unused CG PUSCH occasions.

In some embodiments, the sending module is further configured for
the terminal to indicate to the network-side device a not-required-to-use state or a required-to-use state of each CG PUSCH occasion within a first time period.

In some embodiments, the sending module is further configured for
the terminal to indicate the not-required-to-use state or the required-to-use state of each CG PUSCH occasion within the first time period using a bitmap; where
an indication granularity of the bitmap is any one of the following:
a granularity of CG PUSCH occasion,
a granularity of serving cell, or
a granularity of CG Config.

In some embodiments, the sending module is further configured for
the terminal to indicate to the network-side device first information corresponding to the used CG PUSCH occasions or second information corresponding to the unused CG PUSCH occasions within a preset indication period.

In some embodiments, the first information is used to indicate any one of the following:
N used CG PUSCH occasions starting from the 1st used CG PUSCH occasion, where N is a positive integer, or
all used CG PUSCH occasions from the 1st used CG PUSCH occasion to the last used CG PUSCH occasion; and
the second information is used to indicate any one of the following:
starting from the 1st unused CG PUSCH occasion, none of CG PUSCH occasions before a first CG PUSCH occasion is required to use,
from the 1st unused CG PUSCH occasion to a second CG PUSCH occasion, none of CG PUSCH occasions covered or involved is required to use, or
none of M CG PUSCH occasions starting from the 1st unused CG PUSCH occasion is required to use, where M is a positive integer, where
the 1st used CG PUSCH occasion is any one of the following:
the 1st CG PUSCH occasion carrying the service data,
the 1st CG PUSCH occasion carrying uplink control information UCI corresponding to the first indication information,
the 1st CG PUSCH occasion actually occupied or transmitted by the terminal, or
a CG PUSCH occasion following the last CG PUSCH occasion indicated by a previous window, where the window is a window corresponding to of the first indication information in time domain, and the window includes at least one used CG PUSCH occasion, or the window includes at least one used CG PUSCH occasion and at least one unused CG PUSCH occasion; where
the 1st unused CG PUSCH occasion is explicitly indicated by the terminal in uplink control information UCI, or the 1st unused CG PUSCH occasion is implicitly determined based on the last used CG PUSCH occasion.

In some embodiments, the first information includes at least one of the following:
a starting position or starting index of the used CG PUSCH occasions,
an ending position or ending index of the used CG PUSCH occasions, or
the number of the used CG PUSCH occasions; and
the second information includes at least one of the following:
a starting position or starting index of the unused CG PUSCH occasions,
an ending position or ending index of the unused CG PUSCH occasions, or
the number of the unused CG PUSCH occasions.

In some embodiments, the first information includes at least one of the following:
starting times of the time period corresponding to the used CG PUSCH occasions,
ending times of the time period corresponding to the used CG PUSCH occasions, or
a duration of the time period corresponding to the used CG PUSCH occasions; and
the second information includes at least one of the following:
starting times of the time period corresponding to the unused CG PUSCH occasions,
ending times of the time period corresponding to the unused CG PUSCH occasions, or
a duration of the time period corresponding to the unused CG PUSCH occasions.

In some embodiments, the sending module is further configured for
the terminal to indicate to the network-side device whether a specified used CG PUSCH occasion within the first time period is the last used CG PUSCH occasion.

In some embodiments, the first indication information is carried by a CG PUSCH, or the first indication information is carried by a periodic PUCCH or a periodic PUSCH, or the first indication information is carried by a semi-persistent PUCCH or a semi-persistent PUSCH; and
an indication period of the first indication information is determined in any one of the following manners:
being explicitly configured by higher-layer signaling,
being determined based on a period of a time-division duplex TDD frame structure, and
being determined based on a period of the service data.

In some embodiments, a time interval between first UCI carrying the first indication information and an earliest unused CG PUSCH occasion corresponding to the first indication information is not less than a first duration; where
a starting time of the time interval is an ending time of a PUCCH or PUSCH carrying UCI, an ending time of the time interval is a starting time of the earliest unused CG PUSCH occasion corresponding to the first indication information, and the first UCI is one of earliest A pieces of UCI indicating the earliest unused CG PUSCH occasion, where A is a positive integer.

In some embodiments, the number of the used CG PUSCH occasions indicated by the first indication information is any one of the following, so as to indicate to the network-side device that an additional uplink transmission resource is required:
a reserved value; and
a value greater than the number of preconfigured CG PUSCH occasions.

In some embodiments, the number of the unused CG PUSCH occasions indicated by the first indication information is any one of the following, so as to indicate to the network-side device that an additional uplink transmission resource is required:
a reserved value; and
a negative value.

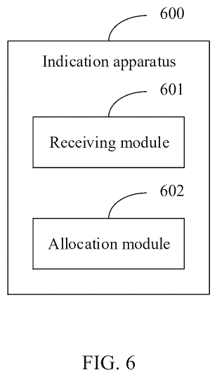

Referring to FIG. 6, an embodiment of this application provides an indication apparatus 600, the apparatus is applied to a network-side device, and the apparatus includes:
a receiving module 601 configured for the network-side device to receive first indication information from a terminal during a duration of service data or in a case that a CG resource is present; and
an allocation module 602 configured for the network-side device to reallocate a time-frequency resource corresponding to unused CG PUSCH occasions based on the first indication information; where
the CG resource includes at least one configured grant physical uplink shared channel occasion CG PUSCH occasion, the first indication information is used to indicate positions or indexes of used CG PUSCH occasions and positions or indexes of unused CG PUSCH occasions in the CG resource, the first indication information is used to indicate a time period corresponding to used CG PUSCH occasions and a time period corresponding to unused CG PUSCH occasions in the CG resource, or the first indication information is used to indicate used CG PUSCH occasions and/or unused CG PUSCH occasions in the CG resource within a first time period; and
the CG PUSCH occasion is determined to support resource recycling.

In some embodiments, the receiving module is further configured for
the network-side device to receive, from the terminal, first information corresponding to the used CG PUSCH occasions and second information corresponding to the unused CG PUSCH occasions.

In some embodiments, the receiving module is further configured for
the network-side device to receive a not-required-to-use state or a required-to-use state of each CG PUSCH occasion within the first time period that are indicated by the terminal.

In some embodiments, the receiving module is further configured for
the network-side device to receive a not-required-to-use state or a required-to-use state of each CG PUSCH occasion within the first time period that are indicated by the terminal by using a bitmap; where
an indication granularity of the bitmap is any one of the following:
a granularity of CG PUSCH occasion,
a granularity of serving cell, and
a granularity of CG Config.

In some embodiments, the receiving module is further configured for
the network-side device to receive first information corresponding to the used CG PUSCH occasions or second information corresponding to the unused CG PUSCH occasions within a preset indication period that are indicated by the terminal.

In some embodiments, the first information is used to indicate any one of the following:
N used CG PUSCH occasions starting from the 1st used CG PUSCH occasion, where N is a positive integer, and
all used CG PUSCH occasions from the 1st used CG PUSCH occasion to the last used CG PUSCH occasion; and
the second information is used to indicate any one of the following:
starting from the 1st unused CG PUSCH occasion, none of CG PUSCH occasions before a first CG PUSCH occasion is required to use,
from the 1st unused CG PUSCH occasion to a second CG PUSCH occasion, none of CG PUSCH occasions covered or involved is required to use, and
none of M CG PUSCH occasions starting from the 1st unused CG PUSCH occasion is required to use, where M is a positive integer, where
the 1st used CG PUSCH occasion is any one of the following:
the 1st CG PUSCH occasion carrying the service data,
the 1st CG PUSCH occasion carrying uplink control information UCI corresponding to the first indication information,
the 1st CG PUSCH occasion actually occupied or transmitted by the terminal, and
a CG PUSCH occasion following the last CG PUSCH occasion indicated by a previous window, where the window is a window corresponding toof the first indication information in time domain, and the window includes at least one used CG PUSCH occasion, or the window includes at least one used CG PUSCH occasion and at least one unused CG PUSCH occasion; where
the 1st unused CG PUSCH occasion is explicitly indicated by the terminal in uplink control information UCI, or the 1st unused CG PUSCH occasion is implicitly determined based on the last used CG PUSCH occasion.

In some embodiments, the first information includes at least one of the following:
a starting position or starting index of the used CG PUSCH occasions,
an ending position or ending index of the used CG PUSCH occasions, and
the number of the used CG PUSCH occasions; and
the second information includes at least one of the following:
a starting position or starting index of the unused CG PUSCH occasions,
an ending position or ending index of the unused CG PUSCH occasions, and
the number of the unused CG PUSCH occasions.

In some embodiments, the first information includes at least one of the following:
starting times of the time period corresponding to the used CG PUSCH occasions,
ending times of the time period corresponding to the used CG PUSCH occasions, and
a duration of the time period corresponding to the used CG PUSCH occasions; and
the second information includes at least one of the following:
starting times of the time period corresponding to the unused CG PUSCH occasions,
ending times of the time period corresponding to the unused CG PUSCH occasions, and
a duration of the time period corresponding to the unused CG PUSCH occasions.

In some embodiments, the receiving module is further configured for
the network-side device to receive an indication indicated by the terminal whether a specified used CG PUSCH occasion within the first time period is the last used CG PUSCH occasion.

In some embodiments, the first indication information is carried by a CG PUSCH, or the first indication information is carried by a periodic PUCCH or a periodic PUSCH, or the first indication information is carried by a semi-persistent PUCCH or a semi-persistent PUSCH; and
an indication period of the first indication information is determined in any one of the following manners:
being explicitly configured by higher-layer signaling,
being determined based on a period of a TDD frame structure, and
being determined based on a period of the service data.

In some embodiments, a time interval between first UCI carrying the first indication information and an earliest unused CG PUSCH occasion corresponding to the first indication information is not less than a first duration; where
a starting time of the time interval is an ending time of a PUCCH or PUSCH carrying UCI, an ending time of the time interval is a starting time of the earliest unused CG PUSCH occasion corresponding to the first indication information, and the first UCI is one of earliest A pieces of UCI indicating the earliest unused CG PUSCH occasion, where A is a positive integer.

In some embodiments, the number of the used CG PUSCH occasions indicated by the first indication information is any one of the following, so as to indicate to the network-side device that an additional uplink transmission resource is required:
a reserved value; and
a value greater than the number of preconfigured CG PUSCH occasions.

In some embodiments, the number of the unused CG PUSCH occasions indicated by the first indication information is any one of the following, so as to indicate to the network-side device that an additional uplink transmission resource is required:
a reserved value; and
a negative value.

The indication apparatus in the embodiments of this application may be an electronic device, for example an electronic device having an operating system, or may be a component of an electronic device, for example, an integrated circuit or a chip. The electronic device may be a terminal or other devices than terminals. For example, the terminal may include but is not limited to the types of the terminal 11 listed above, and the other devices may be servers, Network Attached Storage (NAS), or the like, which are not specifically limited in the embodiments of this application.

The indication apparatus provided in this embodiment of this application is capable of implementing the processes implemented in the method embodiments in FIG. 2 and FIG. 4, with the same technical effects achieved. To avoid repetition, details are not described herein again.

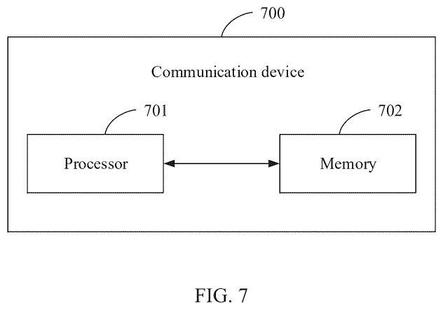

As shown in FIG. 7, an embodiment of this application further provides a communication device 700 including a processor 701 and a memory 702. The memory 702 stores a program or an instruction capable of running on the processor 701. For example, in a case that the communication device 700 is a terminal, when the program or the instruction is executed by the processor 701, the steps of the foregoing indication method embodiment are implemented, with the same technical effects achieved. If the communications device 700 is a network-side device, when the program or instruction is executed by the processor 701, the steps of the foregoing embodiments of the indication method are implemented, with the same technical effects achieved. To avoid repetition, details are not described herein again.

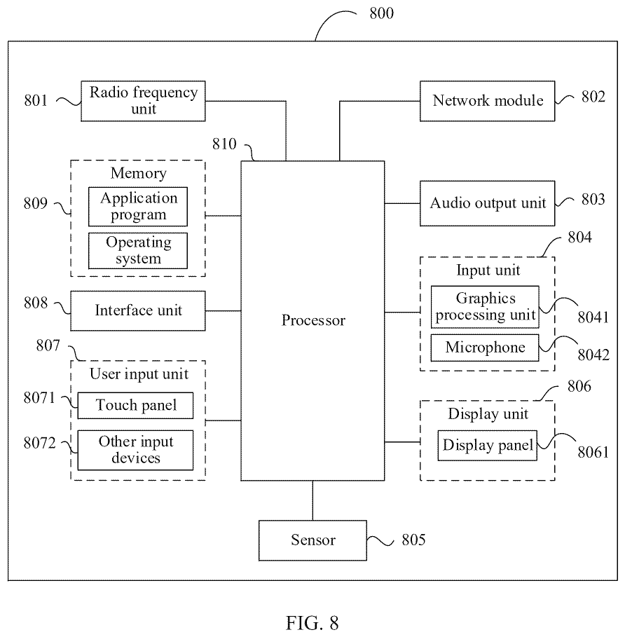

An embodiment of this application further provides a terminal, including a processor and a communication interface. The communication interface is configured for the terminal to send first indication information to a network-side device during a duration of service data or in a case that a CG resource is present. The CG resource includes at least one configured grant physical uplink shared channel occasion CG PUSCH occasion, the first indication information is used to indicate positions or indexes of used CG PUSCH occasions and positions or indexes of unused CG PUSCH occasions in the CG resource, the first indication information is used to indicate a time period corresponding to used CG PUSCH occasions and a time period corresponding to unused CG PUSCH occasions in the CG resource, or the first indication information is used to indicate used CG PUSCH occasions and/or unused CG PUSCH occasions in the CG resource in a first time period; and the CG PUSCH occasion is determined to support resource recycling. This terminal embodiment corresponds to the foregoing method embodiment on the terminal side. All processes and implementations in the foregoing method embodiment can be applicable to this terminal embodiment, with the same technical effect achieved. FIG. 8 is a schematic diagram of a hardware structure of a terminal for implementing embodiments of this application.

The terminal 800 includes but is not limited to at least part of these components: a radio frequency unit 801, a network module 802, an audio output unit 803, an input unit 804, a sensor 805, a display unit 806, a user input unit 807, an interface unit 808, a memory 809, a processor 810, and the like.

Persons skilled in the art can understand that the terminal 800 may further include a power supply (for example, a battery) supplying power to the components, and the power supply may be logically connected to the processor 810 through a power management system. In this way, functions such as charge management, discharge management, and power consumption management are implemented by using the power management system. The structure of the terminal shown in FIG. 8 does not constitute any limitation on the terminal, and the terminal may include more or fewer components than shown in the figure, or combine some of the components, or have different arrangements of the components. Details are not described herein.

It can be understood that in this embodiment of this application, the input unit 804 may include a Graphics Processing Unit (GPU) 8041 and a microphone 8042. The graphics processing unit 8041 processes image data of a still picture or video obtained by an image capture apparatus (for example, a camera) in a video capture mode or an image capture mode. The display unit 806 may include a display panel 8061. The display panel 8061 may be configured in a form of a liquid crystal display, an organic light-emitting diode display, or the like. The user input unit 807 includes at least one of a touch panel 8071 and other input devices 8072. The touch panel 8071 is also referred to as a touchscreen. The touch panel 8071 may include two parts: a touch detection apparatus and a touch controller. The other input devices 8072 may include but are not limited to a physical keyboard, a function button (for example, a volume control button or a power on/off button), a trackball, a mouse, and a joystick. Details are not described herein.

In an embodiment of this application, the radio frequency unit 801 receives downlink data from a network-side device and sends the data to the processor 810 for processing; and the radio frequency unit 801 can additionally send uplink data to the network-side device. Generally, the radio frequency unit 801 includes but is not limited to an antenna, an amplifier, a transceiver, a coupler, a low noise amplifier, and a duplexer.

The memory 809 may be adapted to store software programs or instructions and various data. The memory 809 may include a first storage are for storing programs or instructions and a second storage area for storing data. The first storage area may store an operating system, an application program or instructions required by at least one function (for example, a sound playback function or an image playback function), and the like. Additionally, the memory 809 may be a volatile memory or a non-volatile memory, or the memory 809 may include both a volatile memory and a non-volatile memory. The non-volatile memory may be a Read-Only Memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synchronous link dynamic random access memory (Synch link DRAM, SLDRAM), and a direct rambus random access memory (Direct Rambus RAM, DRRAM). The memory 809 in the embodiments of this application includes but is not be limited to these or any other applicable types of memories.

The processor 810 may include one or more processing units. In some embodiments, the processor 810 may integrate an application processor and a modem processor. The application processor primarily processes operations involving an operating system, user interface, application program, or the like. The modem processor primarily processes radio communication signals, for example, being a baseband processor. It can be understood that the modem processor may be not integrated into the processor 810.

The radio frequency unit 801 is configured for the terminal to send first indication information to a network-side device during a duration of service data or in a case that a CG resource is present; where
the CG resource includes at least one configured grant physical uplink shared channel occasion CG PUSCH occasion, the first indication information is used to indicate positions or indexes of used CG PUSCH occasions and positions or indexes of unused CG PUSCH occasions in the CG resource, the first indication information is used to indicate a time period corresponding to used CG PUSCH occasions and a time period corresponding to unused CG PUSCH occasions in the CG resource, or the first indication information is used to indicate used CG PUSCH occasions and/or unused CG PUSCH occasions in the CG resource within a first time period; and
the CG PUSCH occasion is determined to support resource recycling.

In some embodiments, the radio frequency unit 801 is configured for
the terminal to send to the network-side device first information corresponding to the used CG PUSCH occasions and second information corresponding to the unused CG PUSCH occasions.

In some embodiments, the radio frequency unit 801 is configured for
the terminal to indicate to the network-side device a not-required-to-use state or a required-to-use state of each CG PUSCH occasion within a first time period.

In some embodiments, the radio frequency unit 801 is configured for
the terminal to indicate the not-required-to-use state or the required-to-use state of each CG PUSCH occasion within the first time period using a bitmap; where
an indication granularity of the bitmap is any one of the following:
a granularity of CG PUSCH occasion,
a granularity of serving cell, and
a granularity of CG Config.

In some embodiments, the radio frequency unit 801 is configured for
the terminal to indicate to the network-side device first information corresponding to the used CG PUSCH occasions or second information corresponding to the unused CG PUSCH occasions within a preset indication period.

In some embodiments, the first information is used to indicate any one of the following:
N used CG PUSCH occasions starting from the 1st used CG PUSCH occasion, where N is a positive integer, and
all used CG PUSCH occasions from the 1st used CG PUSCH occasion to the last used CG PUSCH occasion; and
the second information is used to indicate any one of the following:
starting from the 1st unused CG PUSCH occasion, none of CG PUSCH occasions before a first CG PUSCH occasion is required to use,
from the 1st unused CG PUSCH occasion to a second CG PUSCH occasion, none of CG PUSCH occasions covered or involved is required to use, and
none of M CG PUSCH occasions starting from the 1st unused CG PUSCH occasion is required to use, where M is a positive integer, where
the 1st used CG PUSCH occasion is any one of the following:
the 1st CG PUSCH occasion carrying the service data,
the 1st CG PUSCH occasion carrying uplink control information UCI corresponding to the first indication information,
the 1st CG PUSCH occasion actually occupied or transmitted by the terminal, and
a CG PUSCH occasion following the last CG PUSCH occasion indicated by a previous window, where the window is a window corresponding to the first indication information in time domain, and the window includes at least one used CG PUSCH occasion, or the window includes at least one used CG PUSCH occasion and at least one unused CG PUSCH occasion; where
the 1st unused CG PUSCH occasion is explicitly indicated by the terminal in uplink control information UCI, or the 1st unused CG PUSCH occasion is implicitly determined based on the last used CG PUSCH occasion.

In some embodiments, the first information includes at least one of the following:
a starting position or starting index of the used CG PUSCH occasions,
an ending position or ending index of the used CG PUSCH occasions, and
the number of the used CG PUSCH occasions; and
the second information includes at least one of the following:
a starting position or starting index of the unused CG PUSCH occasions,
an ending position or ending index of the unused CG PUSCH occasions, and
the number of the unused CG PUSCH occasions.

In some embodiments, the first information includes at least one of the following:
starting times of the time period corresponding to the used CG PUSCH occasions,
ending times of the time period corresponding to the used CG PUSCH occasions, and
a duration of the time period corresponding to the used CG PUSCH occasions; and
the second information includes at least one of the following:
starting times of the time period corresponding to the unused CG PUSCH occasions,
ending times of the time period corresponding to the unused CG PUSCH occasions, and
a duration of the time period corresponding to the unused CG PUSCH occasions.

In some embodiments, the radio frequency unit 801 is configured for the terminal to indicate to the network-side device whether a specified used CG PUSCH occasion within the first time period is the last used CG PUSCH occasion.

In some embodiments, the first indication information is carried by a CG PUSCH, or the first indication information is carried by a periodic PUCCH or a periodic PUSCH, or the first indication information is carried by a semi-persistent PUCCH or a semi-persistent PUSCH; and
an indication period of the first indication information is determined in any one of the following manners:
being explicitly configured by higher-layer signaling,
being determined based on a period of a time-division duplex TDD frame structure, and
being determined based on a period of the service data.

In some embodiments, a time interval between first UCI carrying the first indication information and an earliest unused CG PUSCH occasion corresponding to the first indication information is not less than a first duration; where
a starting time of the time interval is an ending time of a PUCCH or PUSCH carrying UCI, an ending time of the time interval is a starting time of the earliest unused CG PUSCH occasion corresponding to the first indication information, and the first UCI is one of earliest A pieces of UCI indicating the earliest unused CG PUSCH occasion, where A is a positive integer.

In some embodiments, the number of the used CG PUSCH occasions indicated by the first indication information is any one of the following, so as to indicate to the network-side device that an additional uplink transmission resource is required:
a reserved value; and
a value greater than the number of preconfigured CG PUSCH occasions.

In some embodiments, the number of the unused CG PUSCH occasions indicated by the first indication information is any one of the following, so as to indicate to the network-side device that an additional uplink transmission resource is required:
a reserved value; and
a negative value.

An embodiment of this application further provides a network-side device, including a processor and a communication interface. The communication interface is configured for the network-side device to receive first indication information from a terminal during a duration of service data or in a case that a CG resource is present, and for the network-side device to reallocate a time-frequency resource corresponding to the unused CG PUSCH occasions based on the first indication information, where the CG resource includes at least one CG PUSCH occasion, the first indication information is used to indicate positions or indexes of used CG PUSCH occasions or positions or indexes of unused CG PUSCH occasions in the CG resource, the first indication information is used to indicate a time period corresponding to used CG PUSCH occasions or a time period corresponding to unused CG PUSCH occasions in the CG resource, or the first indication information is used to indicate, within a preset indication period, used CG PUSCH occasions or unused CG PUSCH occasions in the CG resource. This network-side device embodiment corresponds to the foregoing network-side device method embodiment. All processes and implementations in the foregoing method embodiment can be applicable to this network-side device embodiment, with the same technical effect achieved.

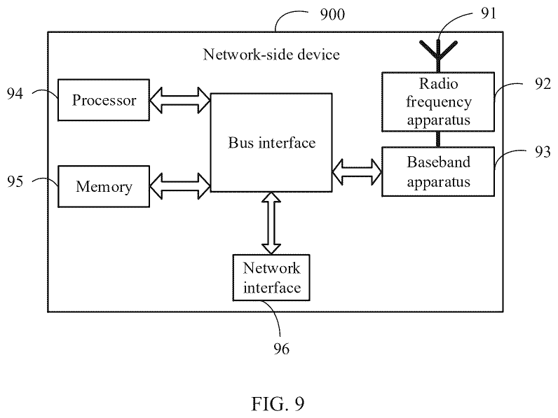

The embodiment of this application further provides a network-side device. As shown in FIG. 9, the network-side device 900 includes an antenna 91, a radio frequency apparatus 92, and a baseband apparatus 93, a processor 94, and a memory 95. The antenna 91 is connected to the radio frequency apparatus 92. In uplink, the radio frequency apparatus 92 receives information through the antenna 91, and sends the received information to the baseband apparatus 93 for processing. In downlink, the baseband apparatus 93 processes to-be-sent information, and sends the information to the radio frequency apparatus 92; and the radio frequency apparatus 92 processes the received information and then sends the information out through the antenna 91.

The method executed by the network-side device in the foregoing embodiments may be implemented on the baseband apparatus 93. The baseband apparatus 93 includes a baseband processor.

For example, the baseband apparatus 93 can include at least one baseband board, which is provided with multiple chips, as shown in FIG. 9, where one chip is, for example, a baseband processor, which is connected to the memory 95 through a bus interface, to invoke the program in the memory 95, and execute the network-side device operations shown in the above method embodiments.

The network-side device may further include a network interface 96. The interface is, for example, a common public radio interface (common public radio interface, CPRI).

The network-side device 900 in this embodiment of the present application further includes: an instruction or program stored in the memory 95 and executable on the processor 94. The processor 94 invokes the instruction or program in the memory 95 to execute the method executed by the modules shown in FIG. 6, with the same technical effects achieved. To avoid repetition, details are not described herein again.

An embodiment of this application further provides a readable storage medium. The readable storage medium stores a program or an instruction, and when the program or instruction is executed by a processor, the processes of the foregoing indication method embodiments are implemented, with the same technical effects achieved. To avoid repetition, details are not described herein again.

The processor is a processor in the terminal described in the foregoing embodiment. The readable storage medium includes a computer-readable storage medium such as a computer read-only memory ROM, a random access memory RAM, a magnetic disk, or an optical disc.

Another embodiment of this application provides a chip. The chip includes a processor and a communication interface, the communication interface is coupled to the processor, and the processor is configured to run a program or an instruction to implement the processes of the foregoing indication method embodiments, with the same technical effects achieved. To avoid repetition, details are not described herein again.

It should be understood that the chip mentioned in the embodiments of this application may also be referred to as a system-level chip, a system chip, a chip system, a system-on-chip, or the like.

An embodiment of this application further provides a computer program/program product, where the computer program/program product is stored in a readable storage medium, and the computer program/program product is executed by at least one processor to implement the processes of the foregoing indication method embodiments, with the same technical effects achieved. To avoid repetition, details are not described herein again.

An embodiment of this application further provides a communication system including a terminal and a network-side device. The terminal may be configured to execute the steps of the foregoing terminal-side method, and the network-side device may be configured to execute the steps of the foregoing network-side device method.

It should be noted that the terms “include”, “include”, or any of their variants are intended to cover a non-exclusive inclusion, such that a process, method, article, or apparatus that includes a series of elements includes not only those elements but also other elements that are not expressly listed, or further includes elements inherent to such process, method, article, or apparatus. Without more constraints, an element preceded by “includes a . . . ” does not preclude the presence of other identical elements in the process, method, article, or apparatus that includes the element. In addition, it should be noted that the scope of the method and apparatus in the embodiments of this application is not limited to functions being performed in the order shown or discussed, but may further include functions being performed at substantially the same time or in a reverse order, depending on the functions involved. For example, the described method may be performed in an order different from the order described, and steps may be added, omitted, or combined. In addition, features described with reference to some examples may be combined in other examples.

Based on the above description of embodiments, persons skilled in the art can clearly understand that the method in the foregoing embodiments can be implemented through a computer software product on a necessary hardware platform or through hardware only. The computer software product is stored in a storage medium (such as a ROM, a RAM, a magnetic disk, or an optical disk), including several instructions to cause a terminal or network-side device to execute the methods described in the various embodiments of this application.

The foregoing describes the embodiments of this application with reference to the accompanying drawings. However, this application is not limited to the foregoing specific embodiments. The foregoing specific embodiments are merely illustrative rather than restrictive. As instructed by this application, persons of ordinary skill in the art may develop many embodiments of other forms without departing from the principle of this application and the protection scope of the claims, and all such embodiments fall within the protection scope of this application.

What is claimed is:

1. An indication method comprising:
sending, by a terminal, first indication information to a network-side device during a duration of service data or when a configured grant (CG) resource is present,
wherein the CG resource comprises at least one configured grant physical uplink shared channel occasion (CG PUSCH occasion), the first indication information is used to indicate positions or indexes of required-to-use CG PUSCH occasions and positions or indexes of not-required-to-use CG PUSCH occasions in the CG resource, or the first indication information is used to indicate a time period corresponding to required-to-use CG PUSCH occasions and a time period corresponding to not-required-to-use CG PUSCH occasions in the CG resource, or the first indication information is used to indicate, within a preset indication period, required-to-use CG PUSCH occasions or not-required-to-use CG PUSCH occasions in the CG resource; and
the CG PUSCH occasion is determined to support resource recycling.

2. The method according to claim 1, wherein the CG PUSCH occasion is determined, based on configuration signaling, to support resource recycling.

3. The method according to claim 2, wherein the configuration signaling comprises: a configuration parameter for a CG Configuration (CG Config) to configure whether the CG Config supports resource recycling for its corresponding CG PUSCH occasions or not.

4. The method according to claim 1, wherein the sending, by a terminal, first indication information to a network-side device comprises:
indicating, by the terminal, to the network-side device a not-required-to-use state or a required-to-use state of each CG PUSCH occasion within a first time period.

5. The method according to claim 4, wherein the indicating, by the terminal, to the network-side device a not-required-to-use state or a required-to-use state of each CG PUSCH occasion within a first time period comprises:
indicating, by the terminal, the not-required-to-use state or the required-to-use state of each CG PUSCH occasion within the first time period using a bitmap,
wherein an indication granularity of the bitmap is any one of the following:
a granularity of CG PUSCH occasion;
a granularity of serving cell; or
a granularity of CG Configuration (CG Config).

6. The method according to claim 5, wherein a number of bits corresponding to the bitmap is configured by RRC signaling.

7. The method according to claim 6, wherein each bit in the bitmap indicates that a corresponding CG PUSCH occasion is required to be used when a value of the bit is 0, and each bit in the bitmap indicates that a corresponding CG PUSCH occasion is not required to be used when a value of the bit is 1.

8. The method according to claim 1, wherein the CG PUSCH occasion is a valid CG PUSCH occasion, wherein the valid CG PUSCH occasion fulfills: symbols occupied by the CG PUSCH occasion are not semi-static downlink symbols.

9. The method according to claim 1, further comprising:
determining, by the terminal, ordering of multiple CG PUSCH occasions based on starting times of the CG PUSCH occasions.

10. The method according to claim 1, wherein
the first indication information is carried by a CG PUSCH, or the first indication information is carried by a periodic PUCCH or a periodic PUSCH, or the first indication information is carried by a semi-persistent PUCCH or a semi-persistent PUSCH; and
an indication period of the first indication information is determined in any one of the following manners:
being explicitly configured by higher-layer signaling,
being determined based on a period of a time-division duplex TDD frame structure, or
being determined based on a period of the service data.

11. The method according to claim 10, wherein when a CG PUSCH occasion is indicated as a not-required-to-use CG PUSCH occasion by the first indication information carried in a previous used CG PUSCH occasion, the CG PUSCH occasion cannot be indicated as a required-to-use CG PUSCH occasion by the first indication information carried in a later used CG PUSCH occasion.

12. The method according to claim 4, wherein
a time interval between first UCI carrying the first indication information and an earliest unused CG PUSCH occasion corresponding to the first indication information is not less than a first duration,
wherein a starting time of the time interval is an ending time of a PUCCH or PUSCH carrying UCI, an ending time of the time interval is a starting time of the earliest unused CG PUSCH occasion corresponding to the first indication information, and the first UCI is one of earliest A pieces of UCI indicating the earliest unused CG PUSCH occasion, wherein A is a positive integer.

13. An indication method comprising:
receiving, by a network-side device, first indication information from a terminal during a duration of service data or when a CG resource is present; and
reallocating, by the network-side device, a time-frequency resource corresponding to unused CG PUSCH occasions based on the first indication information,
wherein the CG resource comprises at least one configured grant physical uplink shared channel occasion (CG PUSCH occasion), the first indication information is used to indicate positions or indexes of required-to-use CG PUSCH occasions and positions or indexes of not-required-to-use CG PUSCH occasions in the CG resource, the first indication information is used to indicate a time period corresponding to required-to-use CG PUSCH occasions and a time period corresponding to not-required-to-use CG PUSCH occasions in the CG resource, or the first indication information is used to indicate required-to-use CG PUSCH occasions or not-required-to-use CG PUSCH occasions in the CG resource within a first time period; and
the CG PUSCH occasion is determined to support resource recycling.

14. The method according to claim 13, wherein the receiving, by a network-side device, first indication information from a terminal comprises:
receiving, by the network-side device, from the terminal first information corresponding to the used CG PUSCH occasions and second information corresponding to the unused CG PUSCH occasions.

15. The method according to claim 13, wherein the receiving, by a network-side device, first indication information from a terminal comprises:
receiving, by the network-side device, a not-required-to-use state or a required-to-use state of each CG PUSCH occasion within the first time period that are indicated by the terminal.

16. The method according to claim 15, wherein the receiving, by the network-side device, a not-required-to-use state or a required-to-use state of each CG PUSCH occasion within the first time period that are indicated by the terminal comprises:
receiving, by the network-side device, a not-required-to-use state or a required-to-use state of each CG PUSCH occasion within the first time period that are indicated by the terminal by using a bitmap,
wherein an indication granularity of the bitmap is any one of the following:
a granularity of CG PUSCH occasion;
a granularity of serving cell; or
a granularity of CG Configure (CG Config).

17. The method according to claim 15, wherein the receiving, by the network-side device, a not-required-to-use state or a required-to-use state of each CG PUSCH occasion within the first time period that are indicated by the terminal comprises:
receiving, by the network-side device, first information corresponding to the used CG PUSCH occasions or second information corresponding to the unused CG PUSCH occasions within a preset indication period that are indicated by the terminal.

18. A terminal, comprising: a memory storing a computer program; and a processor coupled to the memory and configured to execute the computer program to perform operations comprising:
sending first indication information to a network-side device during a duration of service data or when a configured grant (CG) resource is present,
wherein the CG resource comprises at least one configured grant physical uplink shared channel occasion (CG PUSCH occasion), the first indication information is used to indicate positions or indexes of required-to-use CG PUSCH occasions and positions or indexes of not-required-to-use CG PUSCH occasions in the CG resource, or the first indication information is used to indicate a time period corresponding to required-to-use CG PUSCH occasions and a time period corresponding to not-required-to-use CG PUSCH occasions in the CG resource, or the first indication information is used to indicate, within a preset indication period, required-to-use CG PUSCH occasions or not-required-to-use CG PUSCH occasions in the CG resource; and
the CG PUSCH occasion is determined to support resource recycling.

19. The terminal according to claim 18, wherein the CG PUSCH occasion is determined, based on configuration signaling, to support resource recycling.

20. A network-side device, comprising: a memory storing a computer program; and a processor coupled to the memory and configured to execute the computer program to perform the indication method according to claim 13.
